(19) United States
(12) Patent Application Publication
(10) Pub. No.: US 2025/0303793 A1
(43) Pub. Date: Oct. 2, 2025

(54) BICYCLE HUB

(71) Applicant: Christianson Systems, Inc., Blomkest, MN (US)

(72) Inventors: Jim Gerhardt, St. Augusta, MN (US); Shannon Hansen, St. Cloud, MN (US)

(73) Assignee: Christianson Systems, Inc., Blomkest, MN (US)

(21) Appl. No.: 19/237,567

(22) Filed: Jun. 13, 2025

Related U.S. Application Data
(63) Continuation of application No. PCT/US2024/027252, filed on May 1, 2024.
(60) Provisional application No. 63/499,605, filed on May 2, 2023.

(51) Int. Cl. B60B 27/04; B60B 27/02; F16D 41/06; F16D 41/28

(52) U.S. Cl. CPC B60B 27/047; B60B 27/023; F16D 41/28; F16D 2041/0605

(57) ABSTRACT

A bicycle hub with a plurality of interchangeable clutch assemblies for use therein. The clutch assemblies include an outer sleeve that is removable from the bicycle hub. The clutch assemblies are press fit into the hub shell of the bicycle hub. The clutch assemblies include a driver with a freehub. The freehub is rotatably fixed to another component of the driver by a keyed interface that includes one or more undulations.

### CROSS REFERENCE TO RELATED APPLICATION

This application claims the benefit of International Application No. PCT/US2024/27252, filed on May 1, 2024, entitled BICYCLE HUB, which claims the benefit of and priority to U.S. Provisional Application No. 63/499,605, filed on May 2, 2023, entitled BICYCLE HUB, the disclosures of which are hereby incorporated by reference in their entireties.

### BACKGROUND

Freewheeling bicycle hubs are generally known. For example, U.S. Pat. No. 2,211,548 to Frank W. Schwinn issued on Jun. 24, 1940 is directed to a freewheeling bicycle hub configuration. Freewheeling bicycle hubs are configured to enable rotation of the pedals to drive the rotation of the wheels while also allowing the wheels to rotate independent of the rotation of the pedals. This functionality enables the pedals of the bike to be held stationary while the wheels rotate as the bike coasts. Freewheeling bicycle hubs are also commonly referred to as coaster hubs.

Different clutch assemblies have been used to provide freewheeling bicycle hubs. For example, some freewheeling bicycle hubs utilize pawl style clutch assemblies to drive the rotation of the bicycle hub. Other freewheeling bicycle hubs utilize sprags style clutch assemblies. For example, U.S. Pat. No. 9,102,197 to Gerhardt et al., the disclosure of which is hereby incorporated by reference, discloses a freewheeling bicycle hub that uses a sprag style clutch assembly to drive the rotation of the bicycle hub.

### TECHNICAL FIELD

The technical field of the present disclosure relates to freewheeling hubs for use on bicycles.

### SUMMARY

In general terms, this disclosure is directed to a bicycle hub. In some embodiments, and by non-limiting example, the bicycle hub includes a clutch assembly. In some examples, the clutch assembly is interchangeable with alternative clutch assemblies such that a user may select the type of clutch assembly for use with the bicycle hub.

In some embodiments, a bicycle hub comprises a hub shell including an internal cavity. The bicycle hub further comprises an outer sleeve arranged within the internal cavity of the hub shell. The outer sleeve has a central opening. The bicycle hub further comprises a driver arranged within the internal cavity of the hub shell and the central opening of the outer sleeve.

In some embodiments, the bicycle hub comprises a hub shell including an internal cavity. The internal cavity comprises a first diameter portion and a second diameter portion with a wall extending therebetween. The bicycle hub further comprises an outer sleeve arranged within the internal cavity of the hub shell, the outer sleeve includes a central opening and a rear face. A portion of the rear face contacts the wall. The bicycle hub further comprises a cavity defined by the second diameter portion and the rear face. The bicycle hub further comprises a driver arranged within the internal cavity of the hub shell and the central opening of the outer sleeve.

In some embodiments, the bicycle hub comprises a hub shell including an internal cavity and a driver including an inner sleeve portion with a sprag contacting surface that is coaxially arranged with the internal cavity of the hub shell and a freehub portion. The sprag contacting surface includes a first outer diameter and the freehub portion including a second outer diameter. The first outer diameter is larger than the second outer diameter.

In some embodiments, a bicycle hub system comprises a hub shell with an internal cavity. The bicycle hub system further comprises a first clutch assembly comprising an outer sleeve and a driver. The bicycle hub system further comprises a second clutch assembly comprising an outer sleeve and a driver. The outer sleeve of the first clutch assembly is removably secured within the internal cavity of the hub shell. Upon removal of the outer sleeve of the first clutch assembly from the internal cavity of the hub shell, the outer sleeve of the second clutch assembly is removably secured within the internal cavity of the hub shell.

In some embodiments, the clutch assembly includes a hub shell, an outer sleeve, and a driver. In some examples, the outer sleeve is threadedly engaged with the hub shell. In other examples, the outer sleeve is press-fit into the outer shell. In other examples, the outer sleeve includes a threaded portion and a press-fit portion such that the outer sleeve is simultaneously threadedly engaged and press fit into the hub shell.

In some embodiments, the driver includes a freehub. In some examples, the freehub is rotatably fixed to another component of the driver by a keyed interface. In some examples, the freehub includes a male style portion for inserting into a female style freehub engagement portion of the another component of the driver. In some examples, the male style portion includes a smooth outer surface with a plurality of undulations formed thereon. In some examples, the female style freehub engagement portion includes a smooth inner surface with a plurality of undulations formed thereon.

In some embodiments, the bicycle hub includes a hub shell including an internal cavity with internal threads arranged therein. The bicycle hub further includes an outer sleeve arranged within the internal cavity of the hub shell. The outer sleeve includes an outer surface with a threaded portion with external threads that interface with the internal threads of the hub shell. The outer shell further includes a central opening. The bicycle hub further includes a driver arranged within the internal cavity of the hub shell and the central opening of the outer sleeve.

In some embodiments, the bicycle hub includes a hub shell including an internal cavity. The bicycle hub further includes a driver including an inner sleeve portion with a sprag contacting surface that is coaxially arranged with the internal cavity of the hub shell and a freehub portion. The sprag contacting surface includes a first outer diameter. The freehub portion includes a second outer diameter. The first outer diameter is larger than the second outer diameter.

In some embodiments, a clutch assembly for a bicycle hub includes a driver; and an outer sleeve including an inner surface with a clutch element contacting surface arranged thereon. The outer sleeve further includes an outer surface including a threaded portion with external threads arranged thereon.

In some embodiments, a clutch assembly for a bicycle hub includes an outer sleeve including a clutch element contacting surface. The clutch assembly further includes a driver component arranged within the outer sleeve. The driver component includes a freehub engagement portion configured to receive a portion of a freehub therein. The freehub engagement portion has a smooth inner surface with a plurality of undulations arranged thereon.

In some embodiments, a freehub for a bicycle hub includes a cog engagement portion and a driver component engagement portion. The driver component engagement portion is configured to be inserted into a portion of a driver component of the bicycle hub. The driver component engagement portion includes a smooth outer surface with a plurality of undulations arranged thereon.

In some embodiments, a bicycle hub system includes a hub shell with an internal cavity. The bicycle hub system further includes a first clutch assembly comprising an outer sleeve and a driver. The bicycle hub system further includes a second clutch assembly comprising an outer sleeve and a driver. The outer sleeve of the first clutch assembly is removably secured within the internal cavity of the hub shell. Upon removal of the outer sleeve of the first clutch assembly from the internal cavity of the hub shell, the outer sleeve of the second clutch assembly is removably secured within the internal cavity of the hub shell.

### BRIEF DESCRIPTION OF THE DRAWINGS

FIG. 1 is a perspective view of an example bicycle wheel for a bicycle.

FIG. 2 is a perspective view of an example hub.

FIG. 3 is an example cross sectional side view of a first embodiment of the hub of FIG. 2.

FIG. 4 is an exploded view of the hub of FIG. 3.

FIG. 5 is an exploded perspective view of an example driver of the hub of FIG. 3.

FIG. 6 is a perspective view of an example freehub of the driver of FIG. 5.

FIG. 7 is a perspective view of an example inner sleeve of the driver of FIG. 5

FIG. 8 is a perspective view of an example outer sleeve of the hub of FIG. 3.

FIG. 9 is a perspective view of an example sprag frame assembly of the hub of FIG. 3.

FIG. 10 is a cross sectional view of an example hub shell of the hub of FIG. 2.

FIG. 11 is a detail portion of the cross sectional side view of FIG. 3.

FIG. 12 is a cross sectional front view of the hub of FIG. 3.

FIG. 13 is an example cross sectional view of a second embodiment of the hub of FIG. 2.

FIG. 14 is an exploded view of the hub of FIG. 13.

FIG. 15 is an exploded perspective view of an example driver of the hub of FIG. 13.

FIG. 16 is a perspective view of an example pawl assembly of the driver of FIG. 15.

FIG. 17 is an exploded view of the pawl assembly of FIG. 16.

FIG. 18 is a perspective view of an example outer sleeve of the hub of FIG. 14.

FIG. 19 is a is a detail portion of the cross sectional side view of FIG. 13.

FIG. 20 is a cross sectional front view of the hub of FIG. 13.

FIG. 21 is a perspective view of an example inner sleeve of a third embodiment of the hub of FIG. 2.

FIG. 22 is a perspective view of an example outer sleeve of the third embodiment of the hub of FIG. 2.

FIG. 23 is a perspective view of an example clutch member frame assembly of the third embodiment of the hub of FIG. 2.

FIG. 24 is a cross sectional front view of the third embodiment of the hub of FIG. 2.

FIG. 25 is another cross sectional front view of the third embodiment of the hub of FIG. 2.

FIG. 26 is a perspective view of another example hub.

FIG. 27 is an example cross sectional view of a first embodiment of the example hub of FIG. 26.

FIG. 28 is an example cross sectional view of a second embodiment of the example hub of FIG. 26.

FIG. 29 is cross sectional view of another example hub.

FIG. 30 is a perspective view of an example hub shell of the hub of FIG. 29.

FIG. 31 is a cross sectional view of the hub shell of FIG. 30.

FIG. 32 is a front perspective view of an example outer sleeve of the hub of FIG. 29.

FIG. 33 is a rear perspective view of the outer sleeve of FIG. 32.

FIG. 34 is a side view of the hub shell of FIG. 30 with the outer sleeve of FIG. 32 arranged therein.

FIG. 35 is a detail view of an example clutch assembly of the hub of FIG. 29.

FIG. 36 is a cross sectional view of an alternative embodiment of the hub of FIG. 29.

FIG. 37 is a perspective view of an example outer sleeve of the hub of FIG. 36.

FIG. 38 is a detail view of an example clutch assembly of the hub of FIG. 36.

FIG. 39 is cross sectional view of another example hub.

FIG. 40 is a cross sectional view of another example hub.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

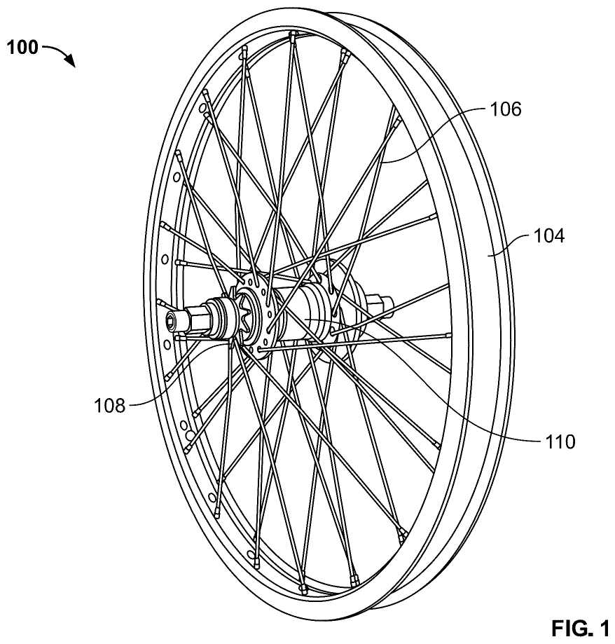

FIG. 1 depicts an example bicycle wheel 100 for a bicycle. The example bicycle wheel 100 includes a rim 104, spokes 106, a cog 108, and a hub 110. The hub 110 includes a hub shell 114 and a freehub 116. In some examples, a tire is arranged around the rim 104 to provide a riding surface for the bicycle. The rim 104 is attached to the hub 110 by the spokes 106, which extend between the hub 110 and the rim 104 and are spaced circumferentially around the hub 110.

The cog 108 is attached to the freehub 116 at a second end of the hub 110. The cog 108 is rotatably fixed to the freehub 116 so that the cog 108 and the freehub 116 rotate in unison. The cog 108 and the freehub 116 are permitted to rotate with respect to the hub shell 114 in a first direction but are restricted from rotating with respect to the hub shell 114 in a second direction. When affixed to a bicycle, a chain (or belt) may be routed around the cog 108 and connected to a chainring on a bicycle. When a user pedals the bicycle, the chainring rotates, and drives the movement of the chain. The movement of the chain causes the rotation of the cog 108. When the wheel is stationary, the rotation of the cog 108 initiates rotation of the freehub 116 in the second direction. However, because the cog 108 and the hub shell 114 are restricted from rotating relative to each other in the second direction, the rotation of the cog 108 in the second direction drives the rotation of the hub shell 114 in the second direction, which causes the rim 104 to rotate and propel the bicycle forward.

If a user stops pedaling while the bicycle is moving, the cog 108 stops rotating, as it is no longer rotated by the movement of the chain. However, because the bicycle remains moving, the rim 104, tire 102, and hub shell 114 continue to rotate. The rotation of the hub shell 114 while the cog 108 and freehub 116 remain stationary results in the respective rotation between the hub shell 114 and the freehub 116 in the first direction. Because the respective rotation between the hub shell 114 and the freehub 116 is permitted by the hub 110, the user is able to coast and ride the bicycle without pedaling. Thus, the freehub 116 is configured to be rotatable with respect to the hub shell 114 in a first direction and is restricted from rotating with respect to the hub shell 114 in a second direction.

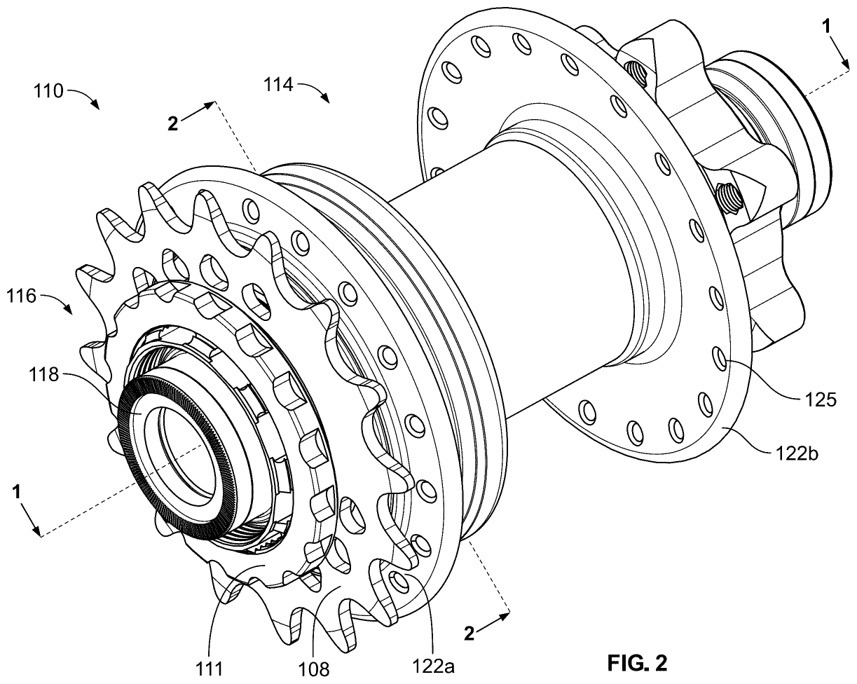

FIG. 2 is perspective view of an example hub 110. The hub 110 includes a hub shell 114, a freehub 116, and a lock ring 111. In some examples, the lock ring 111 engages with threads on the freehub 116 to secure a cog 108 onto the freehub 116. In some examples, the hub 110 further includes an axel assembly 118 that extends through both the hub shell 114 and the freehub 116. The axel assembly 118 is independently rotatable with respect to the hub shell 114 and the freehub 116 in both the first and the second directions. In some examples, the hub 110 is configured for BMX applications.

The hub shell 114 includes a first and second flange 122a, 122b extending radially outward from the hub 110. In some examples, the first and second flange 122a, 122b are spaced apart from each other along the length of the hub shell 114. The first and second flange each include a plurality of spoke engagement members 125, which are formed as holes through each of the first and second flange 122a, 122b that are spaced circumferentially apart from one another.

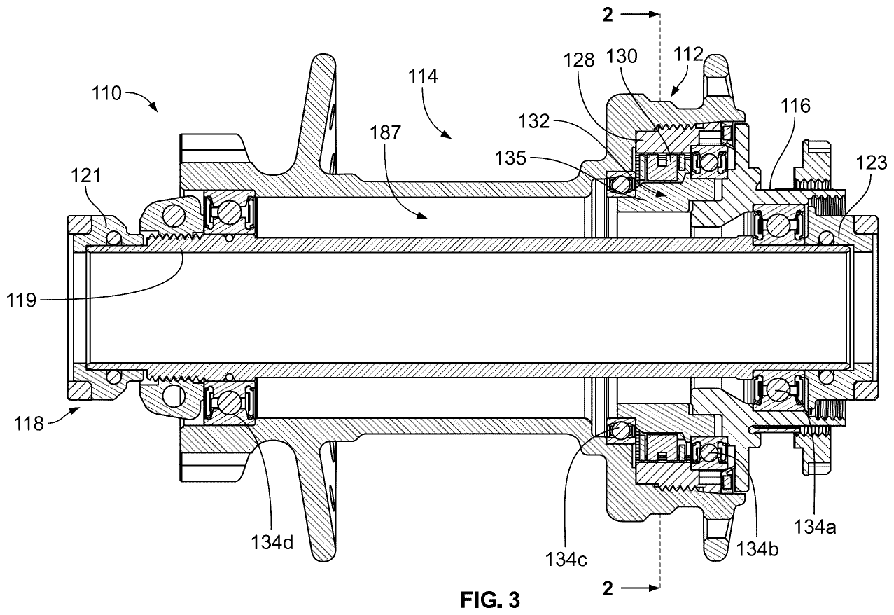

FIG. 3 is a cross sectional side view of the hub 110 along line 1 of FIG. 2. As shown in FIG. 3, the hub 110 includes the hub shell 114, the freehub 116, and the axel assembly 118. The hub 110 further includes a clutch assembly 112 and bearings 134a-d. In some examples, the clutch assembly 112 includes an outer sleeve 128, sprag frame assembly 130, and driver 132. The driver 132 includes one or more driver components. In some examples, the driver components include the freehub 116, and an inner sleeve 135.

As shown in FIG. 3, the hub shell 114 includes an internal cavity 187 in which the other components of the hub 110 are housed. In some examples, such as the example of FIG. 3, the diameter of the internal cavity 187 of the hub shell 114 varies along the length of the hub shell 114. Likewise, in some examples, the diameter of the outer surface of the hub shell 114 varies along the length of the hub shell 114. Furthermore, in some examples, the thickness of the material forming the hub shell 114 is variable along the length of the hub shell 114. In some examples, the material forming the hub shell 114 is thicker at the portion of the hub shell 114 within which the clutch assembly 112 is located than in other areas.

The bearings 134a-d directly or indirectly facilitate rotation between the axel assembly 118, hub shell 114, and the driver 132. As shown in FIG. 3, bearing 134a facilitates rotation between the driver 132 and the axel assembly 118. Bearing 234b facilitates rotation between the driver 132 and the outer sleeve 128. Bearing 234c facilitates rotation between the driver 132 and the hub shell 114. Bearing 234d facilitates rotation between the axel assembly 118 and the hub shell 114.

The axel assembly 118 includes an axel 119 with a first end cap 121 and a second end cap 123.

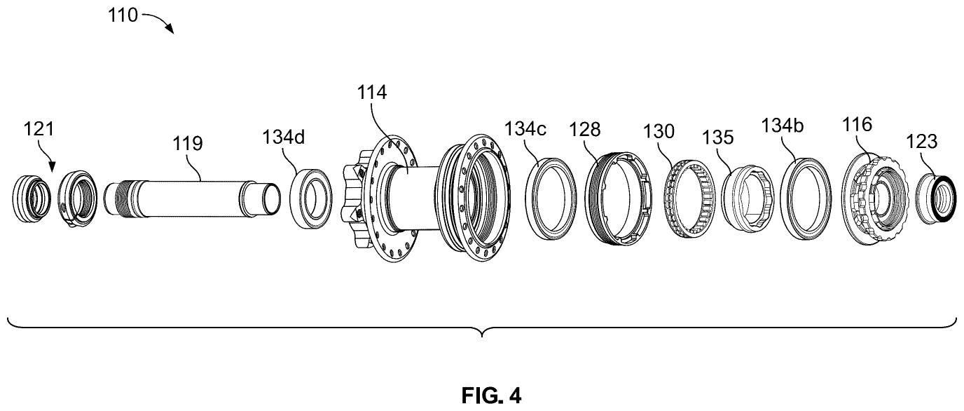

FIG. 4 is an exploded view of the hub 110 of FIG. 3.

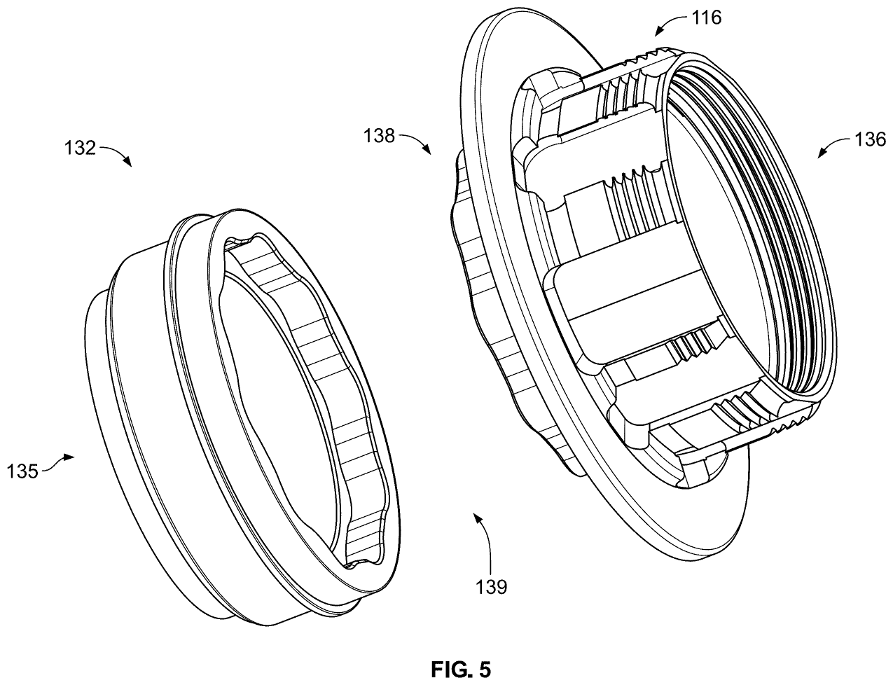

FIG. 5 is an exploded perspective view of the driver 132. As previously described, the driver includes the freehub 116 and the inner sleeve 135. Although the example of FIG. 5 shows the driver 132 as two separate pieces, it should be recognized that the driver 132 may be made from a single, unitary piece. As shown in FIG. 5, the freehub 116 and the inner sleeve 135 of the driver 132 are mated together with a keyed interface 139. In some examples, the freehub 116 and the inner sleeve 135 are formed from the same material. In other examples, the freehub 116 and the inner sleeve 135 are formed from different materials. In some examples, the inner sleeve 135 is formed from a harder material than the freehub 116. In some examples, the inner sleeve 135 is formed from a higher density material, such as, for example, steel, and the freehub 116 is formed from a lower density material, such as, for example, aluminum.

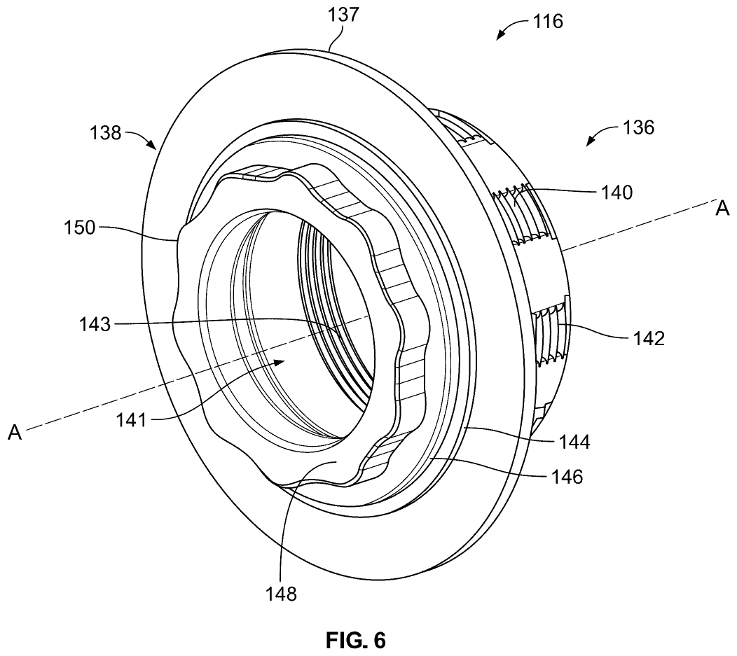

FIG. 6 is a perspective view of the freehub 116. As shown in FIG. 6, the freehub 116 includes a cog engagement portion 136, an inner sleeve engagement portion 138, a flange 137. In some examples, the freehub 116 further includes a central hole 141 that extends through each of the cog engagement portion 136, inner sleeve engagement portion 138, and the flange 137.

The cog engagement portion 136 includes a plurality of splines 140 arranged thereon. In some examples, the splines 140 are arranged in a particular pattern to match up with a plurality of recesses for receiving the splines 120 in the cog 108. Examples of splines 120 are described in U.S. Pat. No. 10,113,597, the entirety of which is hereby incorporated by reference. In some examples, the cog engagement portion 136 is configured to interface with a cog 108 so as to rotatably fix the cog 108 with respect to the freehub 116. In some examples, the cog engagement portion 136 includes internal threads 143 and/or outer threads 142 to engage with a lock ring.

The flange 137 extends around freehub 116 and separates the cog engagement portion 136 from the inner sleeve engagement portion 138. In some examples, the outer diameter of the flange 137 is sized approximately equal to, but slightly smaller than the diameter of the internal cavity 187 of the hub shell 114. In some examples, the flange 137 serves as a cover to protect the components within the internal cavity 187 of the hub shell 114 from an exterior environment outside of the internal cavity 187 of the hub shell 114.

The inner sleeve engagement portion 138 includes a protrusion forming a male style portion of the keyed interface 139 that connects the freehub 116 and the inner sleeve 135. In some examples, the inner sleeve engagement portion 138 also includes a first shoulder portion 144 extending out from the flange 137, and a second shoulder portion 146 extending out from the first shoulder portion 144. In some examples, the male style portion 148 of the keyed interface 139 extends out from the second shoulder portion 146 of the inner sleeve engagement portion 138.

The male style portion 148 of the keyed interface 139 is formed with a plurality of undulations 150 about the outer surface. In such examples, the undulations 150 result in the male style portion 148 having a smooth, wave-like, curving outer surface with a variable outer diameter. For example, as shown in the example of FIG. 6, the male style portion 148 includes ten undulations. In other examples, the male style portion 148 includes greater or fewer undulations about the outer surface. In some examples, the curvature and/or the number of undulations is arbitrary and is selected for aesthetic or ornamental purposes.

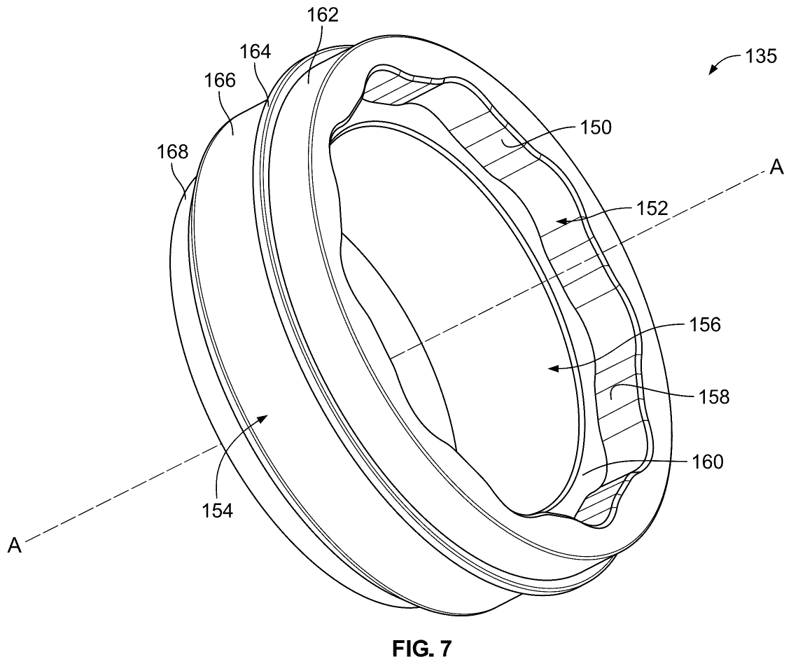

FIG. 7 is a perspective view of the inner sleeve 135. The inner sleeve 135 includes a freehub engagement portion 152, an outer surface 154, and a central hole 156.

The freehub engagement portion 152 includes a female style portion 158 of the keyed interface 139 and an internal shoulder 160.

The female style portion 158 of the keyed interface 139 is formed with a plurality of undulations 150 about the edge of the inner surface. In such examples, the undulations 150 result in the female style portion 158 having a smooth, wave-like, curving inner surface with a variable inner diameter. In some examples, the female style portion 158 of the keyed interface 139 is formed complementarily with the male style portion 148 of the keyed interface 139 such that the number and curvature of the undulations 150 on the female style portion 158 matches the number and curvature of the undulations 150 on the male style portion 148 of the keyed interface 139. In some examples, the curvature and/or the number of undulations is arbitrary and is selected for aesthetic or ornamental purposes.

The internal shoulder 160 of the freehub engagement portion 152 is formed within the inner sleeve 135 and forms a termination of the freehub engagement portion 152. In some examples, the internal shoulder 160 is a flat surface located at the innermost point of the female style portion 158 on the freehub engagement portion 152.

The outer surface 154 of the inner sleeve 135 includes a first support surface 162, a lip 164, a sprag contacting surface 166, and a second support surface 168. As shown in FIG. 7, the first support surface 162 includes a smooth surface with a first diameter. The lip 164 is formed adjacent the first support surface 162 and has a larger diameter than the first support surface 162. The sprag contacting surface 166 includes a smooth surface and has a diameter that is smaller than the diameter of the first support surface 162 and the lip 164. The second support surface 168 includes a smooth outer surface and has a diameter that is smaller than the diameter of the first support surface 162 and the lip 164. Each of the first support surface 162, lip 164, sprag contacting surface 166, and second support surface 168 are separated from each other by a shoulder which serves as a transition between the different diameters on the outer surface 154 on the inner sleeve 135.

As shown and described with reference to FIGS. 5-7, the inner sleeve 135 includes a female style portion 158 of the keyed interface 139 and the freehub 116 includes a male style portion 148 of the keyed interface 139. In other examples, the keyed interface 139 could be 139 formed such that the male style portion 148 is formed on the inner sleeve 135 and the female style portion 158 is formed on the freehub 116. In some examples, the freehub 116 is made from a lighter material than the other driver components, such as the inner sleeve 135. In such examples, providing the male style portion 148 on the freehub 116 and the female style portion 158 on the other driver component, such as the inner sleeve 135, allows for the overall weight of the driver 132 to be decreased.

When mated together, the male style portion 148 of the keyed interface 139 on the freehub 116 fits within the female style portion 158 of the keyed interface 139 of the inner sleeve 135. As shown in FIG. 5, the keyed interface 139 is formed with a plurality of undulations about the outer edge of the interface. The undulating outer surface of the male style portion 148 of the keyed interface 139 on the freehub 116 and the undulating outer surface of the female style portion 158 on inner sleeve 135 are shaped complementarily to each other. When the male style portion 148 of the keyed interface 139 is fitted into the female style portion 158 of the keyed interface, the engagement between the male style portion 148 and the female style portion 158 restricts the relative rotation of the freehub 116 and the inner sleeve 135 with respect to each other.

In some examples, the design of the keyed interface 139 provides manufacturing benefits when manufacturing portions of the keyed interface 139 on either the freehub 116 or the inner sleeve 135.

For example, by using an undulating surface on the male style portion 148 of the inner sleeve engagement portion 138 of the freehub 116, the male style portion 148 can be manufactured using a mill with a bit that has an axis of rotation directed parallel to axis A (illustrated in FIG. 6). In some examples, the central hole 141, the first shoulder portion 144, the second shoulder portion 146, and the flange 137 are all manufactured using a mill with a bit that has an axis of rotation that is directed parallel to axis A. Thus, in these examples, the undulating surface on the male style portion 148, the central hole 141, the first shoulder portion 144, and the second shoulder portion 146 can all be milled with the workpiece oriented in the same direction. This reduces machining complexity and machine time needed to produce the freehub 116.

Similarly, by using an undulating surface on the female style portion 158 of the freehub engagement portion 152 of the inner sleeve 135, the freehub engagement portion 152 can be manufactured using a mill with a bit that has an axis of rotation that is directed parallel to axis A (illustrated in FIG. 7). In some examples, the central hole 156, the first support surface, the lip 164, the sprag contacting surface 166, and the second support surface 168 are all manufactured using a mill with a bit that has an axis of rotation that is directed parallel to axis A. Thus, in these examples, two or more of the: undulating surface on the female style portion 158, the central hole 156, the first support surface, the lip 164, the sprag contacting surface 166, and the second support surface 168 can all be milled with the workpiece oriented in the same direction. This reduces machining complexity and machine time needed to produce the freehub 116.

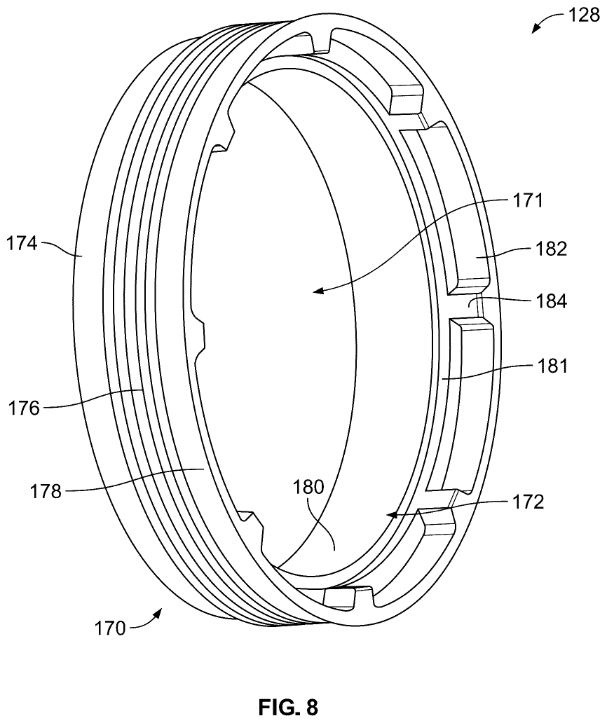

FIG. 8 is a perspective view of the outer sleeve 128. The outer sleeve 128 is formed as a ring and includes an outer surface 170, an inner surface 172 and a central opening 171. The outer sleeve 128 may be formed from a variety of materials. In some examples, the outer sleeve 128 is formed from steel.

In some examples, the outer surface 170 includes a press fit portion 174 and a threaded portion 176. The press fit portion 174 is a first press fit portion 174 and the outer surface 170 further includes a second press fit portion 178. In some examples, the threaded portion 176 is arranged between the first press fit portion 174 and the second press fit portion 178.

The inner surface 172 includes a sprag contacting surface 180, a bearing contacting surface 181, and a featured periphery 182. In some examples, the featured periphery 182 includes one or more tool engagement features 184 arranged thereon. In some examples, the featured periphery 182 is configured to engage with a removal tool for removing the outer sleeve 128 from the hub shell 114. In some examples, the sprag contacting surface 180 is formed as a smooth inner surface.

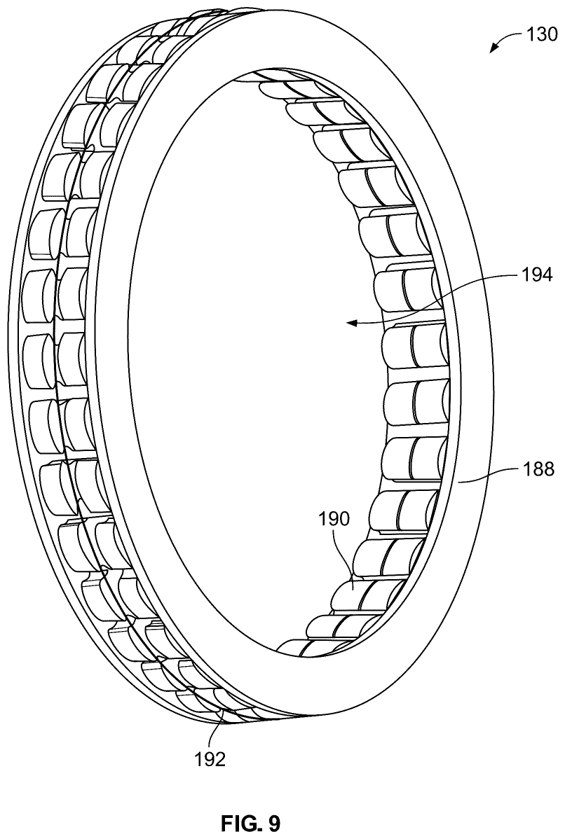

FIG. 9 is a perspective view of an example sprag frame assembly 130. In some examples, the sprag frame assembly 130 includes a frame 188 and one or more clutch elements. In some examples, the clutch elements are sprags 190. In some examples, the sprag frame assembly 130 further includes a retaining spring 192 that wraps around the circumference of the frame 188 to help retain the sprags 190 in place on the frame 188. In the example of FIG. 9, the sprags 190 are permitted to rotate in place on the frame 188. In some examples, the frame 188 includes an opening 194. The opening 194 has an inner diameter that is larger than the diameter of the sprag contacting surface 166 of the outer surface 154 of the inner sleeve 135. In some examples, the opening 194 of the frame 188 has an outer diameter that is smaller than the diameter of the central opening 171 of the outer sleeve 128. In some examples, the sprag frame assembly 130 is arranged within the hub 110 so that the sprag contacting surface 166 inner sleeve 135 extends within the opening 194 of the sprag frame assembly 130 and the sprag frame assembly 130 is within the central opening 171 of the outer sleeve 128. In this example, the sprag frame assembly 130 is arranged radially between the inner sleeve 135 and the outer sleeve 128. In some examples, when arranged in this configuration, the sprag contacting surface 166 of the inner sleeve 135 is configured to be arranged at the same lateral position relative to the sprag contacting surface 180 of the outer sleeve 128. The sprags 190 are configured to be arranged at the same lateral position relative to both the sprag contacting surface 166 of the inner sleeve 135 and the sprag contacting surface 180 of the outer sleeve 128.

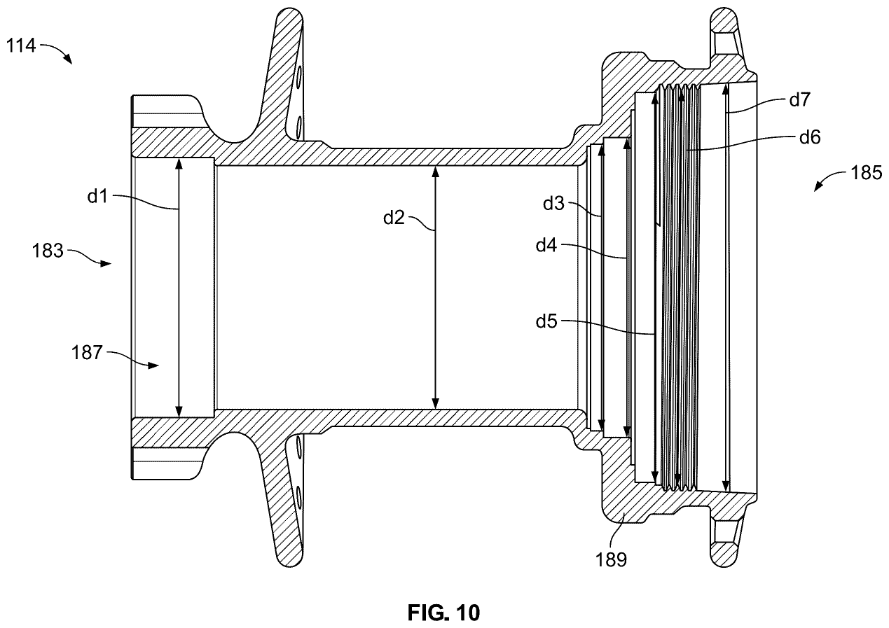

FIG. 10 is a cross sectional view of the hub shell 114 of the hub 110 along line 1 of FIG. 2. The hub shell 114 includes a first end 183 and a second end 185. The hub shell 114 also includes an internal cavity 187 with a varying internal diameter. In some examples, moving from the first end 183 to the second end 185, the internal cavity 187 includes a first diameter portion of d1, a second diameter portion of d2, a third diameter portion of d3, a fourth diameter portion of d4, a fifth diameter portion of d5, a sixth diameter portion of d6, and a seventh diameter portion of d7.

In some examples, the size of the varying diameter portions of the internal cavity 187 is as follows:
d2<d1<d3<d4<d5<d6<d7

In some examples, each of the portions of the internal cavity 187 have a constant internal diameter. In some examples, the diameters of one or more of the portions of the internal cavity 187 have a varying internal diameter. For example, as shown in FIG. 10, the diameter of the seventh diameter portion d7 of the internal cavity 187 is tapered such that the diameter is larger at an end of the seventh diameter d7 portion that is closer to the second end 185 of the hub shell 114 than it is at an end that is closer to the first end 183 of the hub shell 114.

In some examples, each of the portions of the internal cavity 187 have a smooth inner surface. In some examples, one or more of the portions of the internal cavity 187 of the hub shell 114 have a threaded surface. For example, as shown in FIG. 10, the diameter of the sixth diameter portion d6 includes a threaded inner surface.

In some examples, one or more of the portions of the internal cavity 187 include a sharp transition such that the portions of the internal cavity 187 are separated by a shoulder.

In some examples, the hub shell 114 varies in material thickness along the length of the hub shell 114. In some examples, the hub shell 114 includes a reinforced external shoulder 189 at a point above the fourth diameter portion d4 and the fifth diameter portion d5. In some examples, the reinforced external shoulder 189 extends over the sixth diameter portion d6 as well. In some examples, the reinforced external shoulder 189 is formed such that the hub shell 114 is thicker around the reinforced external shoulder 189 than it is at other points along the outer surface of the hub shell 114. In some examples, the reinforced external shoulder 189 provides enhanced structural strength to the hub shell 114 around the fourth diameter portion d4, the fifth diameter portion d5, and the sixth diameter portion d6.

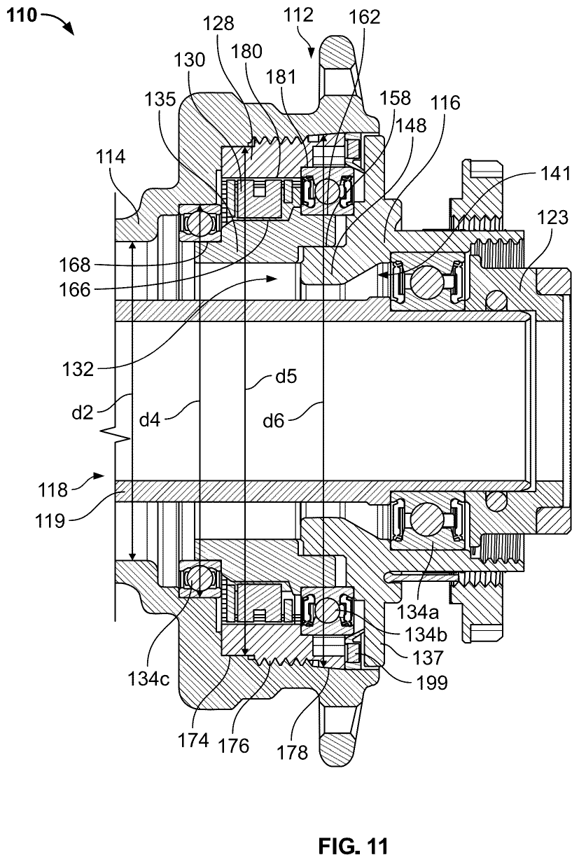

FIG. 11 is a zoomed in cross sectional side view of a portion of the hub 110 and clutch assembly 112 along line 1 of FIG. 2. In some examples, the clutch assembly 112 is arranged within the internal cavity 187 of the hub shell 114.

As shown in the example of FIG. 11, the bearing 134c is within the hub shell 114 and contacts the inner surface of the fourth diameter portion d4 of the hub shell 114.

The outer sleeve 128 is arranged within the hub shell 114 at the fifth diameter portion d5, the sixth diameter portion d6, and the seventh diameter portion d7. In the example of FIG. 11, the press fit portion 174 of the outer sleeve 128 is press fitted into the smooth inner surface of the fifth diameter portion d5. The threaded portion 176 is threadedly engaged with the threaded inner surface of the sixth diameter portion d6. The second press fit portion 178 is press fitted into the smooth inner surface of the seventh diameter portion d7. In some examples, the second press fit portion 178 is tapered so as to match the tapered diameter of the seventh diameter portion d7.

In some examples, the threaded portion 176 provided on the outer sleeve 128 provides the ability to easily insert and remove the outer sleeve 128 from the hub shell 114, while the press fit portions 174, 178 aid in providing frictional force with respect to the hub shell 114 so as to prevent the rotation of the outer sleeve 128 with respect to the hub shell 114 when the outer sleeve 128 is arranged within the hub shell 114 and used with the clutch assembly 112. In some examples, both the threaded portion 176 and the press fit portions 174, 178 work together to provide frictional force against the hub shell 114 so as to rotatably secure the outer sleeve 128 to the hub shell 114 when the hub 110 is in use. Thus, in some examples, the threaded portion 176 provides the benefit of allowing the outer sleeve 128 to be interchangeable and easily removable while still allowing the outer sleeve 128 to remain rotationally fixed with respect to the hub shell 114 while in use.

The inner sleeve 135 is arranged within the hub shell 114 within the fourth diameter portion d4, the fifth diameter portion d5, the sixth diameter portion d6, and the seventh diameter portion d7. The inner sleeve 135 contacts the bearing 134c such that the second support surface 168 of the inner sleeve 135 fits within the opening of the bearing 134c. In some examples, the second support surface 168 of the inner sleeve 135 is pressed into the opening of the bearing 134c.

In some examples, as seen in FIG. 11, the sprag contacting surface 166 includes a diameter that is larger than or equal to the diameter of the freehub 116. In some examples, the sprag contacting surface 166 is approximately 24 mm in diameter, such as, for example, 24 mm in diameter. In some examples, the sprag contacting surface 166 is approximately 29 mm in diameter, such as, for example, 29 mm in diameter. In some examples, the sprag contacting surface 166 is approximately 34 mm in diameter, such as, for example, 34 mm in diameter. In some examples, the larger diameter of the sprag contacting surface 166 requires a larger diameter sprag frame assembly 130 and therefore a larger diameter outer sleeve 128. In some examples, by including a sprag contacting surface 166 with an outer diameter that is larger or equal to the outer diameter of the freehub 116, the frictional force of the sprag frame assembly 130 with respect to the inner sleeve 135 and the outer sleeve 128 is increased. This results in the ability to provide a thinner sprag frame assembly 130, thereby reducing the overall weight of the clutch assembly 112.

The sprag frame assembly 130 is arranged within the fifth diameter portion d5 and the sixth diameter portion d6 of the hub shell 114. The sprag frame assembly 130 is arranged around the sprag contacting surface 166 of the inner sleeve 135. The sprag frame assembly is also arranged within the outer sleeve 128 such that the sprag frame assembly 130 contacts the sprag contacting surface 180 of the outer sleeve.

The freehub 116 is arranged partially within the hub shell 114 such that a portion of the freehub 116 extends into one or more of the sixth diameter portion d6 and the seventh diameter portions d7 of the hub shell 114. As shown in FIG. 11, the freehub 116 is arranged such that the male style portion 148 of the freehub 116 extends into and mates with the inner sleeve 135 to form the driver 132. When mated with the inner sleeve 135, the freehub 116 is arranged such that the flange 137 extends over the opening to the internal cavity 187 of the hub shell 114 at the second end 185 of the hub shell 114. In some examples, the hub 110 further includes a gasket 199 arranged within the seventh diameter portion d7 of the hub shell 114 that contacts the flange 137 of the freehub 116 so as to seal the clutch assembly 112 within the hub shell 114 from the external environment.

The bearing 134b is arranged within the sixth diameter portion d6 and the seventh diameter portion d7 of the hub shell 114. In some examples, the bearing 134b contacts the outer sleeve 128, the inner sleeve 135, and the freehub 116. In some examples, the outer surface of the bearing 134b is configured to contact the bearing contacting surface 181 of the outer sleeve 128. In some examples, the outer surface of the bearing 134b is configured to be pressed into the bearing contacting surface 181 of the outer sleeve 128. The inner surface of the bearing 134b is configured to contact the first support surface 162 of the inner sleeve 135 and the and the second shoulder portion 146 of the freehub 116. In some examples, the bearing 134b is configured to be pressed onto one or more of the first support surface 162 of the inner sleeve 135 and the second shoulder portion 146 of the freehub 116. In some examples, when the inner sleeve engagement portion 138 of the freehub 116 is inserted into the freehub engagement portion 152 of the inner sleeve 135, the bottom surface of the male style portion 148 does not contact the internal shoulder 160 of the inner surface. Rather, the insertion of the inner sleeve engagement portion 138 of the freehub 116 into the freehub engagement portion 152 of the inner sleeve 135 is halted by the arrangement of the bearing 134b between lip 164 of the inner sleeve 135 and the second shoulder portion 146 of the freehub 116. In some examples, the bearings 134b, 134c facilitate rotational movement of the driver 132 with respect to the outer sleeve 128 and the hub shell 114. In some examples, the arrangement of the bearing 134b, the inner sleeve 135, the freehub 116, and the outer sleeve 128 decreases the overall weight of the hub 110 because it allows for a single (as opposed to multiple) bearings to be used to contact the outer sleeve 128, the inner sleeve 135, and the freehub 116.

The bearing 134a is arranged outside of the internal cavity 187 of the hub shell 114. Rather, the bearing 134a is arranged within the central hole 141 of the freehub 116. The bearing 134a contacts an internal surface of the freehub 116 and an external surface of the axel 119 so as to permit relative rotational movement of the axel 119 with respect to the freehub 116. In this example, the axel 119 is also able to freely rotate with respect to the hub shell 114.

The end caps 121, 123 are arranged at the end of the axel 119. In the example of FIG. 11, the axel 119 is arranged within the central hole 141 of the freehub 116. The end caps 121, 123 restricts the lateral movement of the freehub 116 so as to prevent the freehub 116 from disengaging with the inner sleeve 135 of the driver 132.

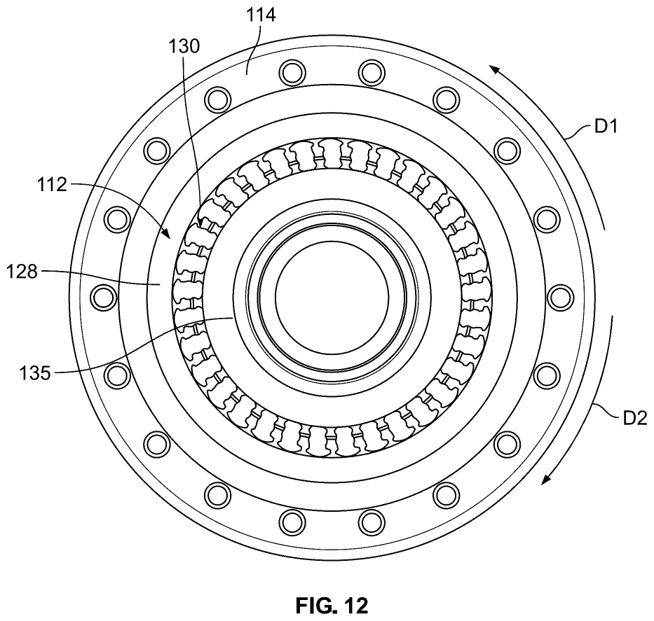

FIG. 12 is a cross sectional front view of the hub 110 with the clutch assembly 112 along line 2 of FIG. 3. As shown in FIG. 12, the sprag frame assembly 130 is arranged around the inner sleeve 135 and the outer sleeve 128 is arranged around the sprag frame assembly 130. The clutch assembly 112 functions to permit the outer sleeve 128 and the hub shell 114 to rotate freely in a first direction D1 with respect to the inner sleeve 135. The clutch assembly 112 further functions to restrict the outer sleeve 128 and the hub shell 114 from rotating in the second direction D2 with respect to the inner sleeve 135. Examples of the functionality of the hub 110 by use of the clutch assembly 112 is further described in U.S. Pat. No. 9,102,197, the entirety of which is hereby incorporated by reference.

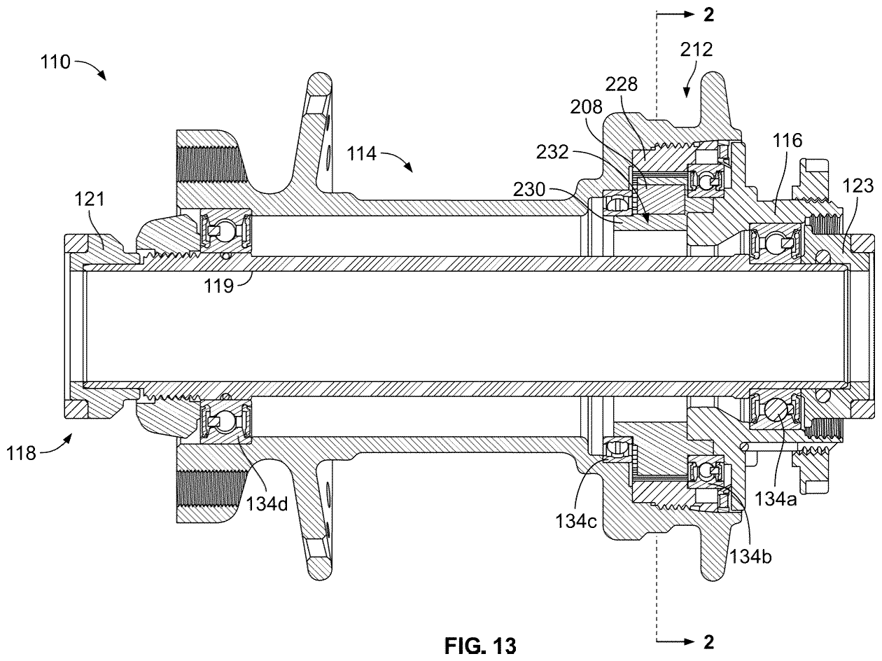

FIG. 13 is a cross sectional view of an alternative embodiment of the hub 110 along line 1 of FIG. 2. As shown in FIG. 13, the hub 110 includes the hub shell 114, the freehub 116, the axel assembly 118, and the bearings 134a-d. In some examples, the hub shell 114, the freehub 116, the axel assembly 118, and the bearings 134a-d are arranged and function as previously described with respect to FIG. 3.

In the example of FIG. 13, the hub 110 further includes a clutch assembly 212. In some examples, the clutch assembly 212 is an interchangeable replacement for the clutch assembly 112 such that either clutch assembly 112 or clutch assembly 212 can be used in the hub 110. In some examples, the clutch assembly 212 includes an outer sleeve 228 and a driver 232. The driver 232 includes one or more driver components. In some examples, the driver components include the freehub 116 and pawl assembly 230.

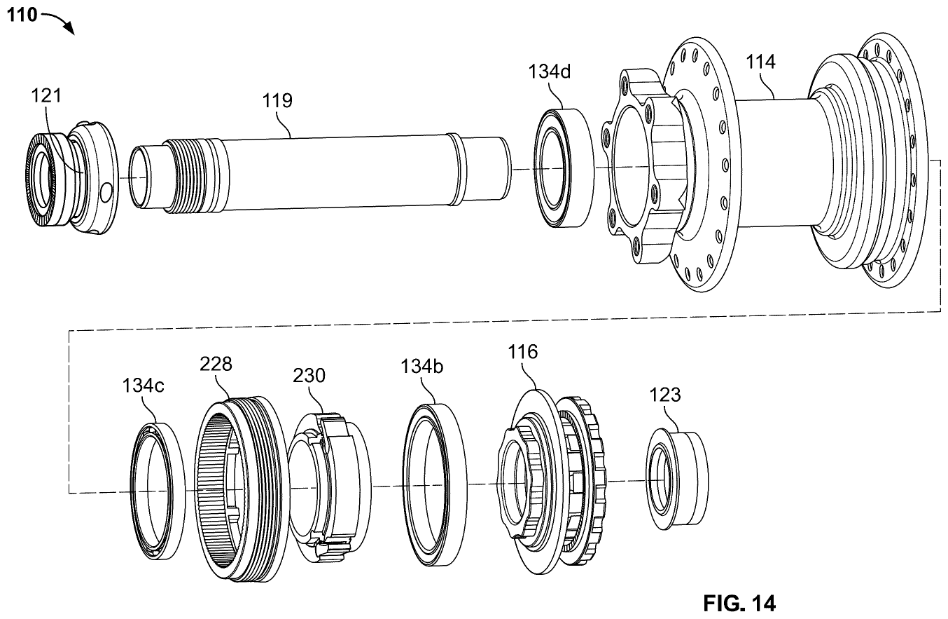

FIG. 14 is an exploded view of the hub 110 of FIG. 13.

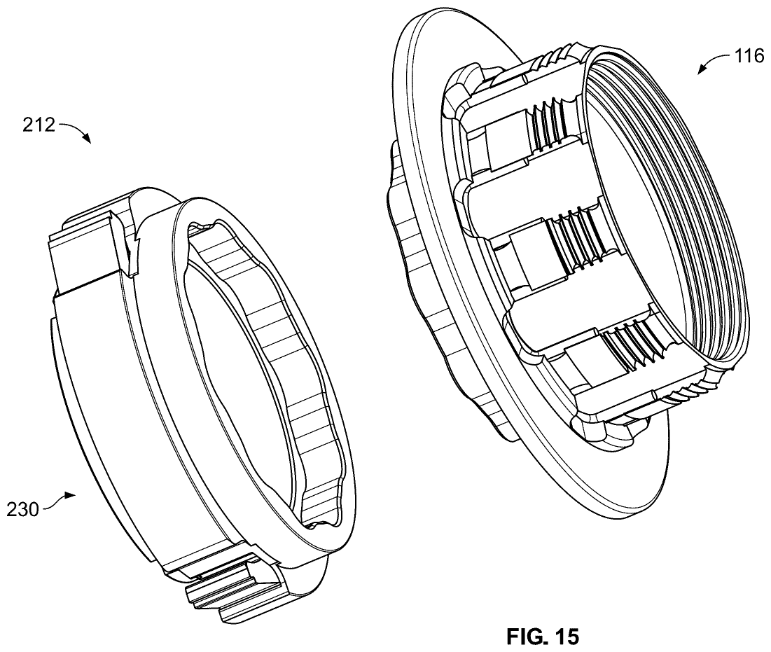

FIG. 15 is an exploded perspective view of the driver 232. As previously described, the driver includes the freehub 116 and the pawl assembly 230. Although the example of FIG. 15 shows the driver 232 as two separate pieces, it should be recognized that the driver 232 may be made from a single, unitary piece. As shown in FIG. 15, the freehub 116 and the pawl assembly 230 of the driver 132 are mated together with a keyed interface 239. In some examples, the keyed interface 239 is similar in many aspects to the keyed interface 139 in FIG. 5. In some examples, the freehub 116 and the pawl assembly 230 are formed from the same material. In other examples, the freehub 116 and the pawl assembly 230 are formed from different materials. In some examples, the pawl assembly 230 is formed from a harder material than the freehub 116. In some examples, the pawl assembly 230 is formed from steel and the freehub 116 is formed from aluminum.

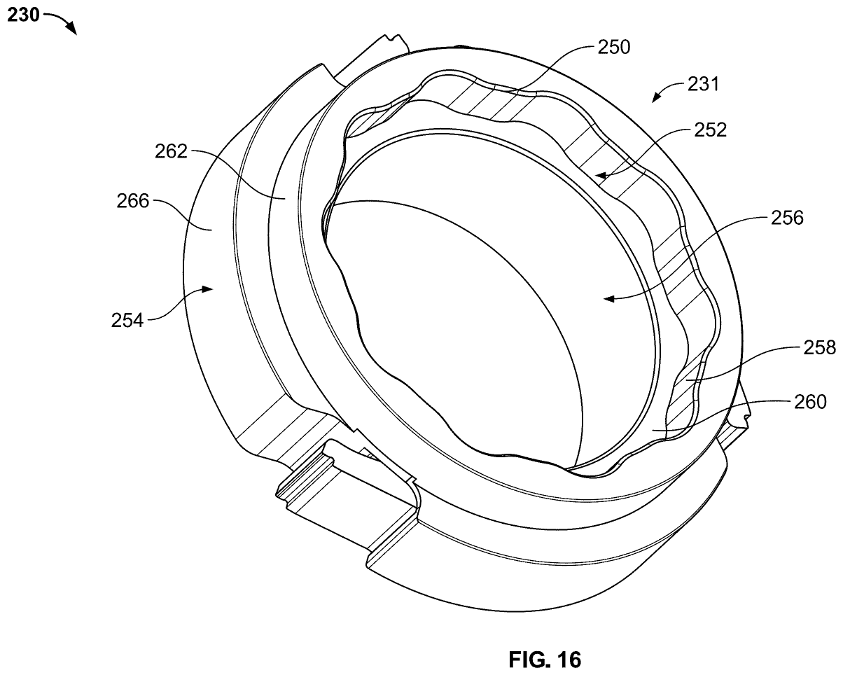

FIG. 16 is a perspective view of the pawl assembly 230. The pawl assembly 230 includes a main body 231 with a freehub engagement portion 252, an outer surface 254, and a central hole 256.

In some examples, the freehub engagement portion 252 is similar in many aspects to the freehub engagement portion 152 of the inner sleeve 135, described with reference to FIG. 7. The freehub engagement portion 252 includes a female style portion 258 of the keyed interface 239 and an internal shoulder 260. In some examples, the female style portion 258 of the keyed interface 239 is formed with a plurality of undulations 250 about the edge of the inner surface.

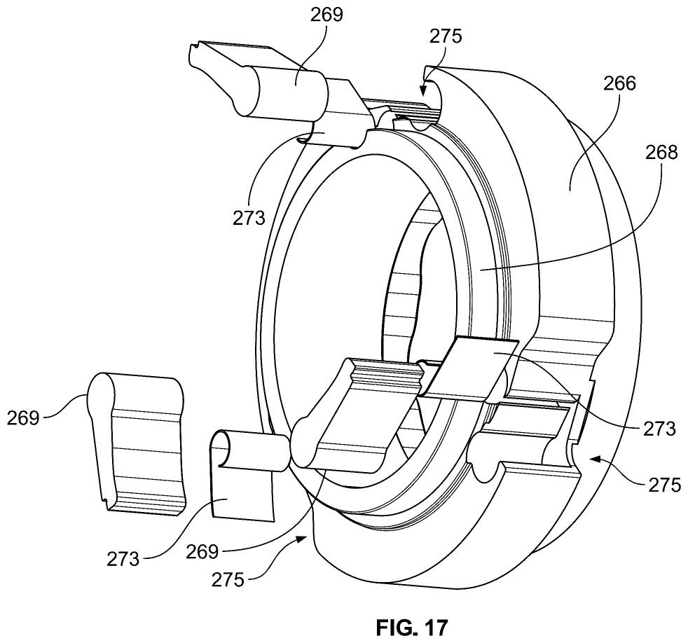

The outer surface 254 of the main body 231 of the pawl assembly 230 includes a first support surface 262, a pawl retaining boss 266, and a second support surface 268 (shown in FIG. 17). As shown in FIG. 16, the first support surface 262 includes a smooth surface with a first diameter. In some examples, the first support surface 262 has the same diameter as the first support surface 162 shown in FIG. 7. Pawl retaining boss 266 is formed adjacent the first support surface 262 and has a larger diameter than the first support surface 262. In some examples, the pawl retaining boss 266 includes a smooth outer surface with recesses formed around its perimeter. The second support surface 268 includes a smooth outer surface and has a diameter that is smaller than the diameter of the first support surface 262 and the pawl retaining boss 266. Each of the first support surface 262, pawl retaining boss 266, and second support surface 268 are separated from each other by a shoulder which serves as a transition between the different diameters on the outer surface 254 on the pawl assembly 230.

In some examples, the female style portion 258 of the main body 231 of the pawl assembly 230 receives the male style portion 148 of the freehub 116 in a similar manner to how the female style portion 158 of the inner sleeve 135 receives the male style portion 148 of the freehub 116, as described with reference to FIGS. 5-7.

FIG. 17 is an exploded view of the pawl assembly 230. As noted above, the pawl assembly 230 includes a main body 231. In some examples, the pawl assembly 230 further includes a plurality of clutch elements and a plurality of spring features 273. In some examples, the clutch elements are pawls 269.

In some examples, the pawl retaining boss 266 further includes pawl receiving pockets 275. For receiving the pawls 269 and the spring features 273. In some examples, when the pawls 269 and the spring features 273 are received within the pawl receiving pockets 275, the spring features 273 push a free end of the pawls 269 out towards the periphery of the pawl retaining boss 266 such that the free end of the pawls extends further out from the center of the pawl assembly 230 than the periphery of the pawl retaining boss 266. In some examples, such as the example of FIG. 17, the pawl assembly 230 is shown including three pawls 269. In other examples, different numbers of pawls may be selected.

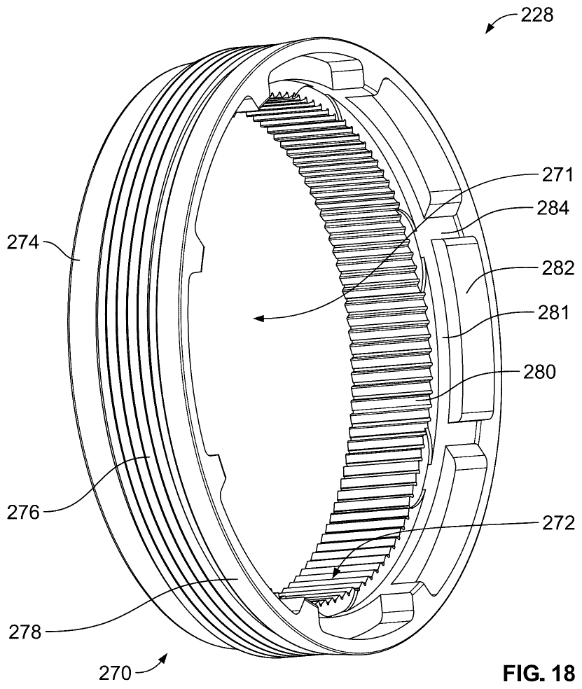

FIG. 18 is a perspective view of the outer sleeve 228. The outer sleeve 228 is formed as a ring and includes an outer surface 270 and an inner surface 272 and a central opening 271. The outer sleeve 228 may be formed from a variety of materials. In some examples, the outer sleeve 228 is formed from steel.

In some examples, the outer surface 270 includes a press fit portion 274 and a threaded portion 276. The press fit portion 274 is a first press fit portion 274 and the outer surface 270 further includes a second press fit portion 278. In some examples, the threaded portion 276 is arranged between the first press fit portion 274 and the second press fit portion 278.

The inner surface 272 includes a pawl contacting surface 280, a bearing contacting surface 281, and a featured periphery 282. In some examples, the featured periphery 282 includes one or more tool engagement features 284 arranged thereon. In some examples, the featured periphery 282 is configured to engage with a removal tool for removing the outer sleeve 228 from the hub shell 114.

In some examples, the pawl contacting surface 280 includes a plurality of teeth arranged around the diameter of the pawl contacting surface 280. In some examples, the teeth on the pawl contacting surface 280 forms locations for engaging free ends of the pawls 269, as shown in FIG. 17.

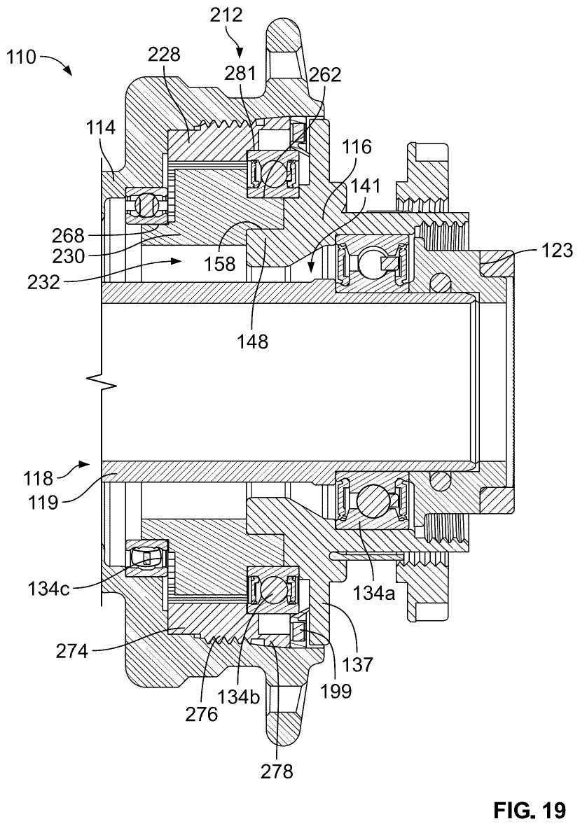

FIG. 19 is a zoomed in cross sectional side view of a portion of the hub 110 and clutch assembly 212 along line 1 of FIG. 2. In some examples, the clutch assembly 212 is arranged within the internal cavity 187 of the hub shell 114. As described below, the hub 110 with the clutch assembly 212 is similar in many aspects to the hub 110 with the clutch assembly 112, described with reference to FIG. 11.

As shown in the example of FIG. 19, the bearing 134c is within the hub shell 114 and contacts the inner surface of the fourth diameter portion d4 of the hub shell 114. In some examples, the bearing 134c is pressed into the inner surface of the fourth diameter portion d4 of the hub shell 114.

The outer sleeve 228 is arranged within the hub shell 114 at the fifth diameter portion d5, sixth diameter portion d6, and seventh diameter portion d7. In the example of FIG. 19, the press fit portion 274 of the outer sleeve 228 is press fitted into the smooth inner surface of the fifth diameter portion d5. The threaded portion 276 is threadedly engaged with the threaded inner surface of the sixth diameter portion d6. The second press fit portion 278 is press fitted into the smooth inner surface of the seventh diameter portion d7. In some examples, the second press fit portion 278 is tapered so as to match the tapered diameter of the seventh diameter portion d7.

The pawl assembly 230 is arranged within the hub shell 114 within the fourth diameter portion d4, the fifth diameter portion d5, the sixth diameter portion d6, and the seventh diameter portion d7. The pawl assembly 230 contacts the bearing 134c such that the second support surface 268 of the pawl assembly 230 fits within the opening of the bearing 134c.

The freehub 116 is arranged partially within the hub shell 114 such that a portion of the freehub 116 extends into one or more of the sixth diameter portion d6 and the seventh diameter portions d7 of the hub shell 114. As shown in FIG. 19, the freehub 116 is arranged such that the male style portion 148 of the freehub 116 extends into and mates with the pawl assembly 230 to form the driver 232. When mated with the pawl assembly 230, the freehub 116 is arranged such that the flange 137 extends over the opening to the internal cavity 187 of the hub shell 114 at the second end 185 of the hub shell 114. In some examples, the hub 110 further includes the gasket 199 arranged within the seventh diameter portion d7 of the hub shell 114 that contacts the flange 137 of the freehub 116 so as to seal the clutch assembly 212 within the hub shell 114 from the external environment.

The bearing 134b is arranged within the sixth diameter portion d6 and the seventh diameter portion d7 of the hub shell 114. In some examples, the bearing 134b contacts the outer sleeve 228, the pawl assembly 230, and the freehub 116. In some examples, the outer surface of the bearing 134b is configured to contact the bearing contacting surface 281 of the outer sleeve 228. The inner surface of the bearing 134b is configured to contact the first support surface 262 of the pawl assembly 230 and the and the second shoulder portion 146 of the freehub 116. Thus, the bearings 134b, 134c facilitate rotational movement of the driver 232 with respect to the outer sleeve 228 and the hub shell 114. In some examples, the arrangement of the bearing 134b, the pawl assembly 230, the freehub 116, and the outer sleeve 228 decreases the overall weight of the hub 110 because it allows for a single (as opposed to multiple) bearings to be used to contact the outer sleeve 228, the pawl assembly 230, and the freehub 116.

The bearing 134a is arranged outside of the internal cavity 187 of the hub shell 114. Rather, the bearing 134a is arranged within the central hole 141 of the freehub 116. The bearing 134a contacts an internal surface of the freehub 116 and an external surface of the axel 119 so as to permit relative rotational movement of the axel 119 with respect to the freehub 116. In this example, the axel 119 is also able to freely rotate with respect to the hub shell 114.

The end caps 121, 123 are arranged at the end of the axel 119. In the example of FIG. 11, the axel 119 is arranged within the central hole 141 of the freehub 116. The end caps 121, 123 restricts the lateral movement of the freehub 116 so as to prevent the freehub 116 from disengaging with the inner sleeve 135 of the driver 132.

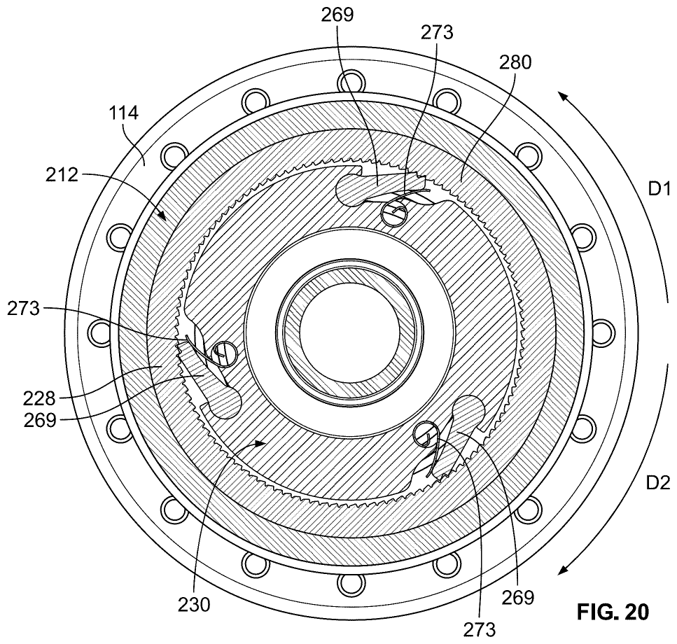

FIG. 20 is a cross sectional front view of the hub 110 with the clutch assembly 212 along line 2 of FIG. 13. As shown in FIG. 20, the pawl assembly 230 is arranged within the outer sleeve 228. As previously noted, the pawls 269 are arranged within the pawl assembly 230 such that the spring features 273 push the free end of the pawls 269 out towards the periphery of the pawl assembly 230 such that the free end of the pawls 269 contact the pawl contacting surface 280 of the outer sleeve 228. The clutch assembly 212 functions to permit the outer sleeve 228 and the hub shell 114 to rotate freely in a first direction D1 with respect to the pawl assembly 230. The clutch assembly 212 further functions to restrict the outer sleeve 128 and the hub shell 114 from rotating in the second direction D2 with respect to the pawl assembly 230.

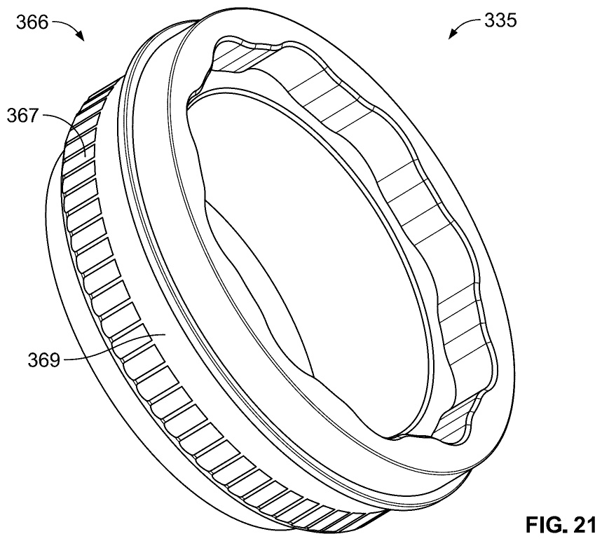

In some examples as described with reference to FIGS. 21-23, an alternative clutch assembly 312 may be provided for use in the hub 110. In some examples, the clutch assembly 312 is an interchangeable replacement for the clutch assembly 112 or the clutch assembly 312 such that either clutch assembly 112, the clutch assembly 212, or the clutch assembly 312 can be used in the hub 110. This allows a user of the hub 110 to selectively choose which style of clutch assembly 112, 212, 312 is used within the hub 110. In some examples, the interchangeable nature of the clutch assemblies 112, 212, 312 within the hub 110 provides the benefit of allowing a user to switch the style of the clutch assembly 112, 212, 312 without needing to remove the entire hub 110 from the wheel of the bicycle, which is known to be a relatively labor-intensive process. In some examples, the interchangeable nature of the clutch assemblies allows a user to select between multiple different pawl style clutch assemblies for use in the hub 110. In other examples, the interchangeable nature of the clutch assemblies allows a user to select between multiple different sprag style clutch assemblies for use in the hub 110. In other examples, the interchangeable nature of the clutch assemblies allows a user to select between multiple different clutch assemblies that include clutch elements with a wedge portion and an interlocking portion for use in the hub 110. In other examples, the interchangeable nature of the clutch assemblies allows a user to select between any of a pawl style clutch assembly, a sprag style clutch assembly, or a clutch assembly that includes clutch elements with a wedge portion and an interlocking portion for use in the hub 110.

In some examples, the clutch assembly 312 includes an outer sleeve 328, a clutch member frame assembly 330, and a driver 332. In some examples, the driver 332 includes one or more driver components, such as the freehub 116 and inner sleeve 335.

FIG. 21 is a perspective view of the inner sleeve 335. In some examples, the inner sleeve 335 is similar in many aspects to the inner sleeve 135 described with reference to FIG. 7. In some examples, the inner sleeve 335 differs from the inner sleeve 135 in that rather than having a completely smooth sprag contacting surface, such as the sprag contacting surface 166 described with reference to FIG. 7, the inner sleeve 335 includes a clutch member contacting surface 366 that includes a featured portion 367 and a smooth portion 369. In some examples, the smooth portion 369 is formed such that it is similar in many aspects to the sprag contacting surface 166 described with reference to FIG. 7. In some examples, the featured portion 367 includes a plurality of teeth arranged around the inner diameter of the featured portion 367. In some examples, the teeth on the featured portion 367 form locations for engaging clutch members. In some examples, the inner sleeve 335 is formed from two parts such that the featured portion 367 and the smooth portion 369 are formed on separate parts of the inner sleeve 335.

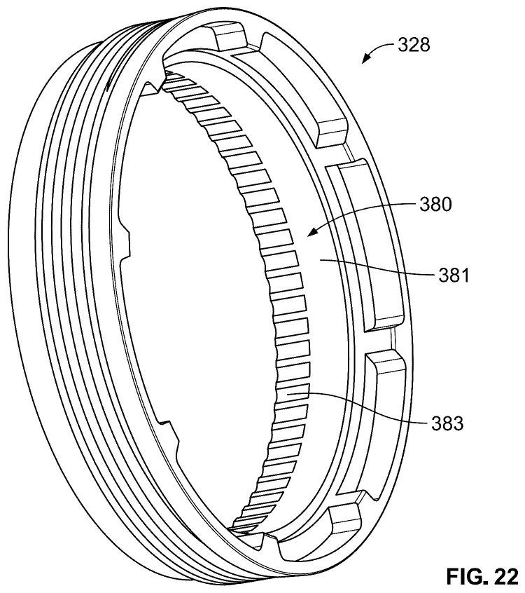

FIG. 22 is a perspective view of the outer sleeve 328. In some examples, the outer sleeve 328 is similar in many aspects to the outer sleeve 128 described with reference to FIG. 7 and the outer sleeve 228 described with reference to FIG. 18. In some examples, each of the outer sleeves 328, 228, 128 include an identical outer surface such that the outer sleeves 328, 228, 128 can be threadedly engaged with the hub shell 114 in an identical manner such that the clutch assemblies 112, 212, 312 can be readily exchanged for one another and removed by removing the outer sleeve 328, 228, 128. In some examples, the outer sleeve 328 differs from the outer sleeve 128 and outer sleeve 228 in that rather than having a smooth sprag contacting surface 180 or a or a featured pawl contacting surface 280, the outer sleeve 328 includes a clutch member contacting surface 380 that includes both a smooth portion 381 and a featured portion 383. In some examples, the smooth portion 381 is formed such that it is similar in many aspects to the sprag contacting surface 180 described with reference to FIG. 8. In some examples, the featured portion 383 is formed such that it is similar in many aspects to the pawl contacting surface 280 of FIG. 18. In some examples, the featured portion 383 includes a plurality of teeth arranged around the inner diameter of the featured portion 383. In some examples, the teeth on the featured portion 383 form locations for engaging clutch members. In some examples, the outer sleeve 328 is formed from two parts such that the featured portion 383 and the smooth portion 381 are formed on separate parts of the outer sleeve 328.

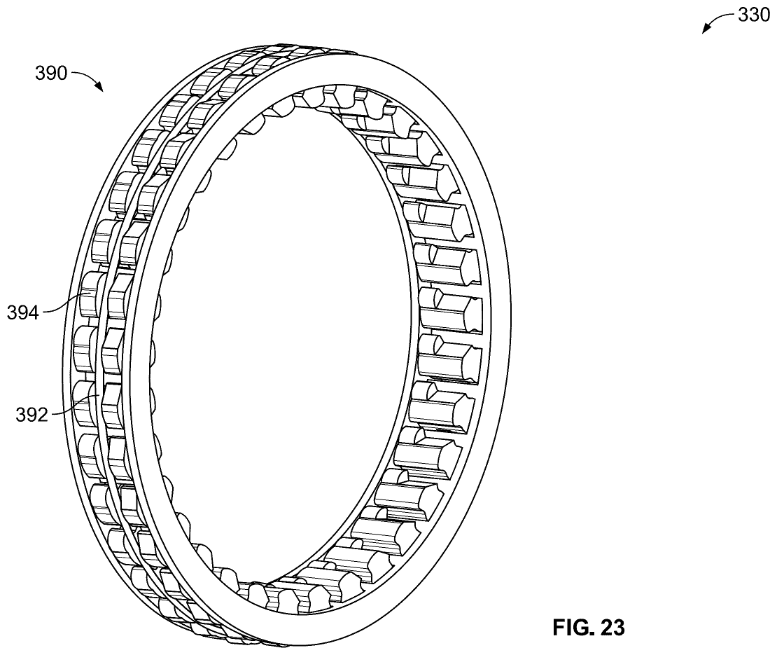

FIG. 23 is a perspective view of an example clutch member frame assembly 330. In some examples, the clutch member frame assembly 330 is similar in many aspects to the sprag frame assembly 130 of FIG. 9. In some examples, the clutch member frame assembly 330 includes a plurality of clutch members 390. In some examples, each of the clutch members 390 each include a wedge portion 392 and an interlocking portion 394.

In some examples, the inner sleeve 335, the outer sleeve 328, and the clutch member frame assembly 330 are arranged within the hub 110 similarly to how the inner sleeve 135, the outer sleeve 128, and the sprag frame assembly 130, as described with reference to FIGS. 11-12.

In some examples, the inner sleeve 335, the outer sleeve 328, and the clutch member frame assembly 330 are arranged such that the wedge portions 392 of the clutch members 390 contact the smooth portion 381 of the outer sleeve 328 and the smooth portion 369 of the inner sleeve 335 in a similar manner to the arrangement shown in FIG. 12.

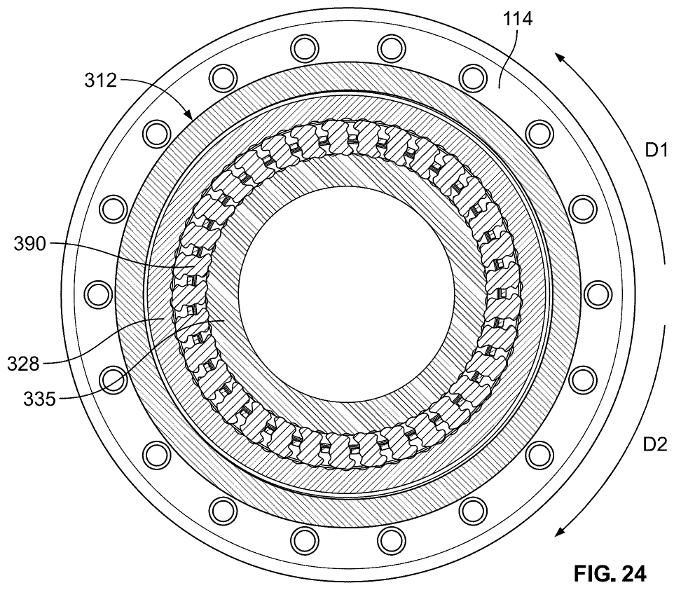

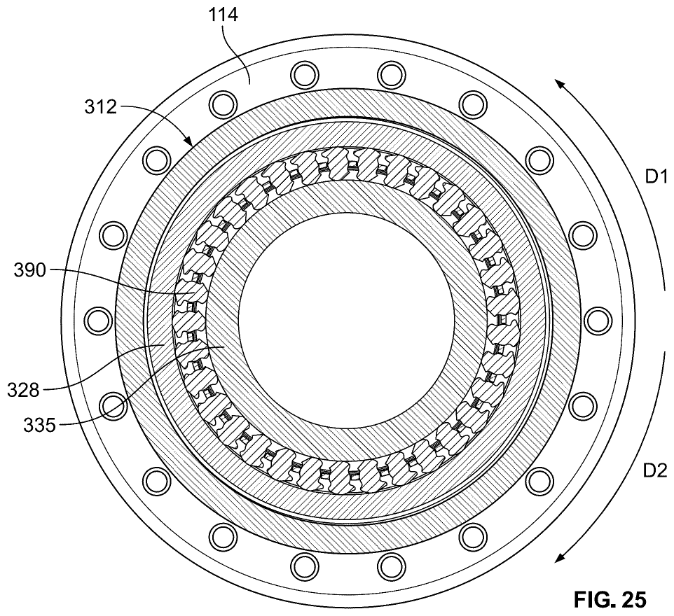

FIGS. 24-25 are cross sectional front views of the example hub 110 with the clutch assembly 312 arranged therein. In some examples, the inner sleeve 335, the outer sleeve 328, and the clutch member frame assembly 330 are further arranged such that the interlocking portions 394 of the clutch members 390 contact the featured portion 383 of the outer sleeve 328 and the featured portion 367 of the inner sleeve 335, as is shown in the example of FIG. 24. Similarly, in some examples, the inner sleeve 335, the outer sleeve 328, and the clutch member frame assembly 330 are further arranged such that the wedge portions 392 of the clutch members 390 contact the smooth portion 381 of the outer sleeve 328 and the smooth portion 369 of the inner sleeve 335, as is shown in the example of FIG. 25.

The clutch assembly 312 functions to permit the outer sleeve 328 and the hub shell 114 to rotate freely in a first direction D1 with respect to the inner sleeve 335. The clutch assembly 312 further functions to restrict the outer sleeve 328 and the hub shell 114 from rotating in the second direction D2 with respect to the inner sleeve 335. Examples of the functionality of the hub 110 by use of the clutch assembly 312 is further described in U.S. Provisional Patent Application No. 63/357,149, the entirety of which is hereby incorporated by reference.

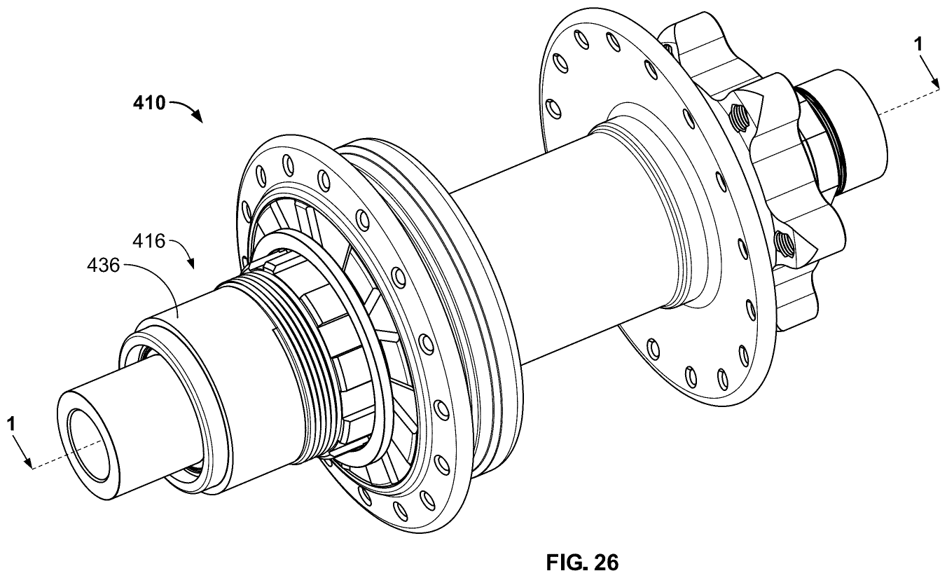

FIG. 26 is a perspective view of another example hub 410. In some examples, the hub 410 is similar in many aspects to the hub 110, as shown in described in FIGS. 2-25.

In some examples, the hub 410 differs from the hub 110 in that the hub 410 is configured for mountain biking applications. In some examples, the hub 410 differs from the hub 110 in that the hub 410 includes a larger freehub 416 that is configured to retain a mountain bike cassette, as opposed to a BMX cog. Thus, in some examples, the freehub 416 includes a cassette engagement portion 436 as opposed to a cog engagement portion 136.

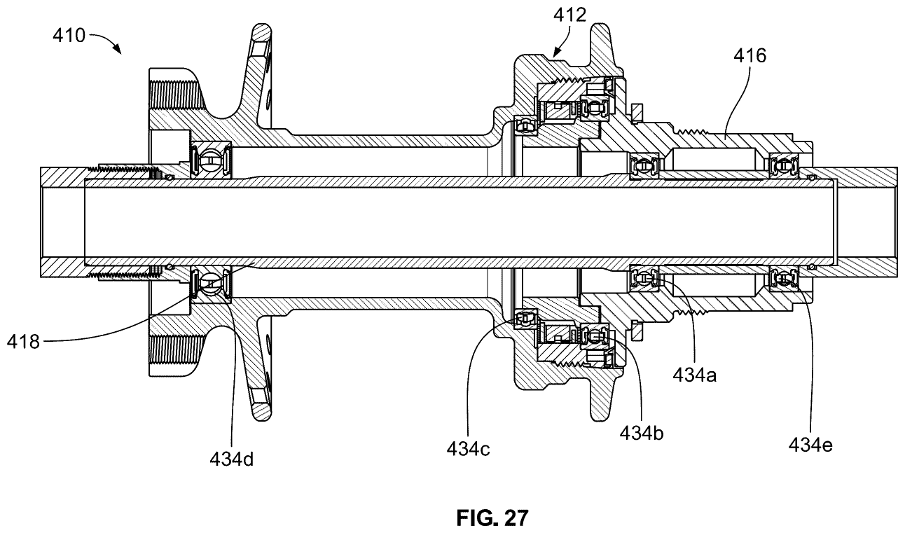

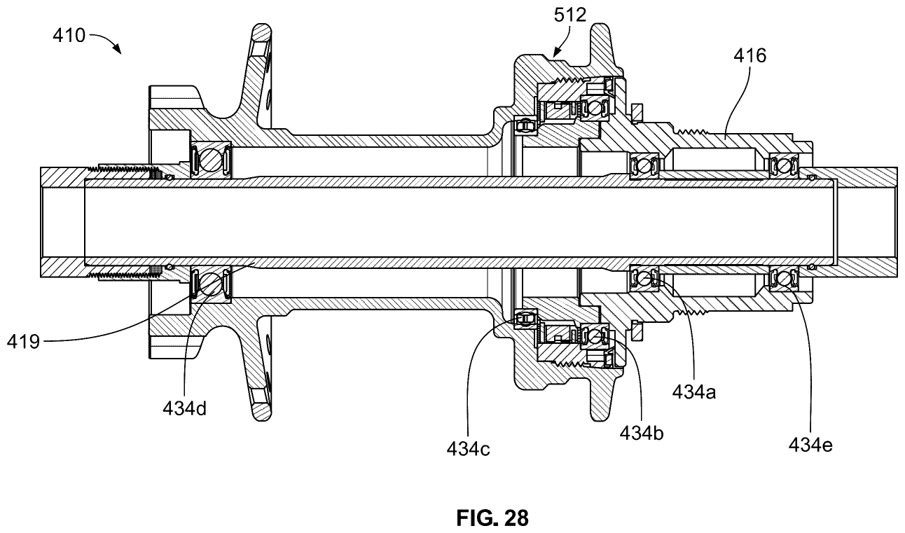

FIGS. 27 and 28 are example cross sectional views of the hub 410 along line 1 of FIG. 26.

FIG. 27 depicts the hub 410 with an example clutch assembly 412 arranged therein. In some examples, the clutch assembly 412 is similar in many aspects to the clutch assembly 112.

FIG. 28 depicts the hub 410 with another example clutch assembly 512 arranged therein. In some examples, the clutch assembly 512 is similar in many aspects to the clutch assembly 212.

In some examples, the hub 410 may also be provided with another example clutch assembly arranged therein. In some examples, such clutch assembly is similar in many aspects to the clutch assembly 312.

In some examples, as described above with respect to clutch assemblies 112, 212, 312, the clutch assemblies 412, 512, 612 are interchangeable with each other for use within the hub 410.

In some examples, as shown in FIGS. 27-28, the hub 410 further includes bearings 434a, 434b, 434c, and 434d. In some examples, bearings 434a, 434b, 434c, and 434d function and are arranged similarly in many aspects to bearings 134a, 134b, 134c, and 134d of the example hub 110. In some examples, the hub 410 further differs from the hub 110 in that the hub 410 further includes an additional bearing 434e. In some examples, the additional bearing 434e is provided between the freehub 416 and an axel 419 of the hub 410 so as to facilitate relative rotation between the freehub 416 and the axel 419.

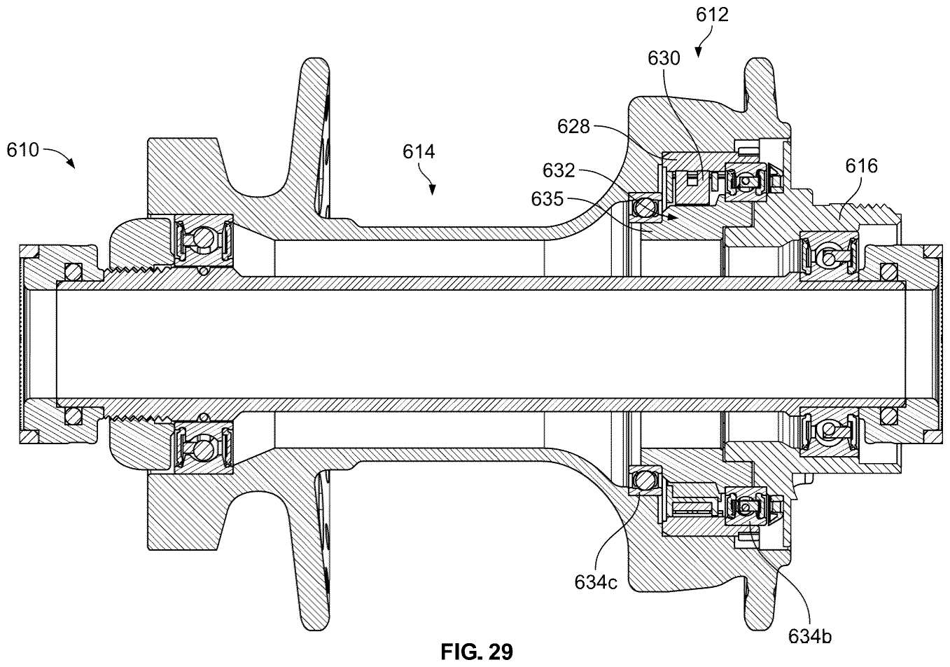

FIG. 29 is cross sectional view of another example hub 610. In some examples, the hub 610 and the components thereof are similar in many aspects to the hub 110 and components thereof, as shown in described in FIGS. 2-25. In some examples, like the hub 110, the hub 610 includes a shell 614, bearings, including bearings 634b and 634c, and a clutch assembly 612. In some examples, the clutch assembly 612 is similar in many aspects to the clutch assembly 112. In some examples, the clutch assembly 612 includes an outer sleeve 628, sprag frame assembly 630, and driver 632. The driver 632 includes one or more driver components. In some examples, the driver components include the freehub 616, and an inner sleeve 635.

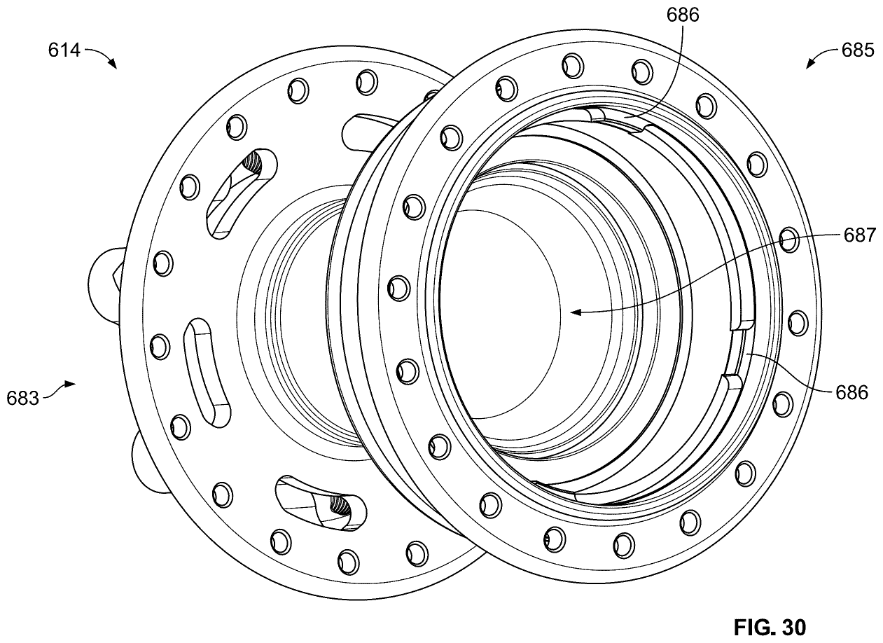

FIG. 30 is a perspective view of the example hub shell 614. In some examples, the hub shell 614 includes an internal cavity 687 that extends from a first end 683 to a second end 685. In some examples, the hub shell 614 further includes one or more protrusions 686 arranged around an interior surface of the of the internal cavity 687 of the hub shell 614. In some examples, the protrusions 686 are arranged near the second end 685 of the hub shell 614 and extend from the interior surface on which they are arranged towards the center of the interior cavity 687 of the hub shell 614. In some examples, the hub shell 614 includes four protrusions 686 circumferentially arranged about the interior cavity 687 of the hub shell 614.

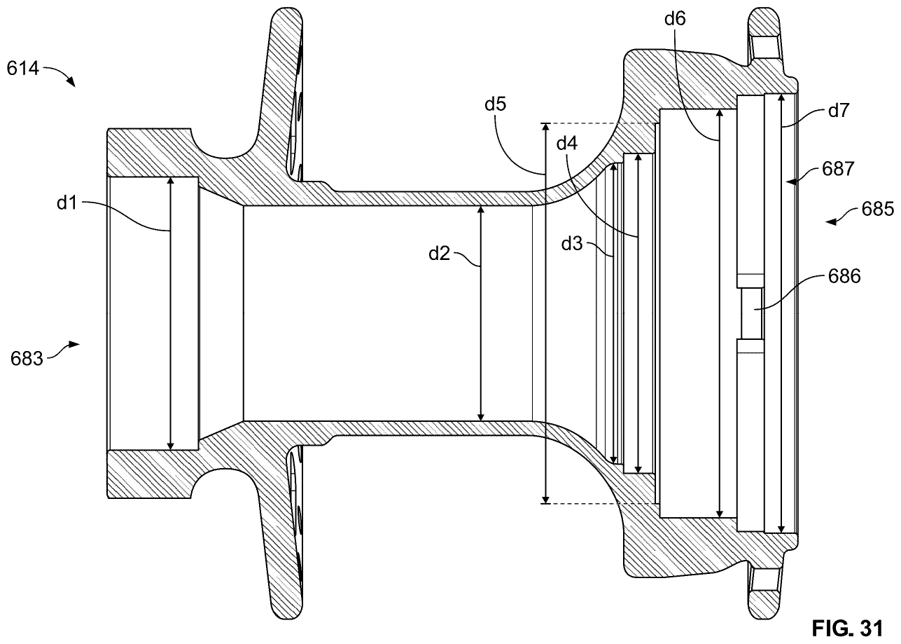

FIG. 31 is a cross sectional view of the hub shell 614 of the hub 610. The hub shell 614. In some examples, the hub shell includes a varying internal diameter of the internal cavity 687. In some examples, moving from the first end 683 to the second end 685, the internal cavity 687 includes a first diameter portion of d1, a second diameter portion of d2, a third diameter portion of d3, a fourth diameter portion of d4, a fifth diameter portion of d5, a sixth diameter portion of d6, and a seventh diameter portion of d7.

In some examples, the size of the varying diameter portions of the internal cavity 687 is as follows:
d2<d1<d3<d4<d5<d6<d7

In some examples, the internal diameter of the hub shell 614 includes a tapered transition between one or more of the varying diameter portions of the internal cavity 687. In other examples, the internal diameter of the hub shell 614 includes a step change transition between one or more of the varying diameter portions of the internal cavity 687. In some examples, each of the varying diameter portions of the internal cavity 687 include a smooth inner surface and do not include threads arranged thereon.

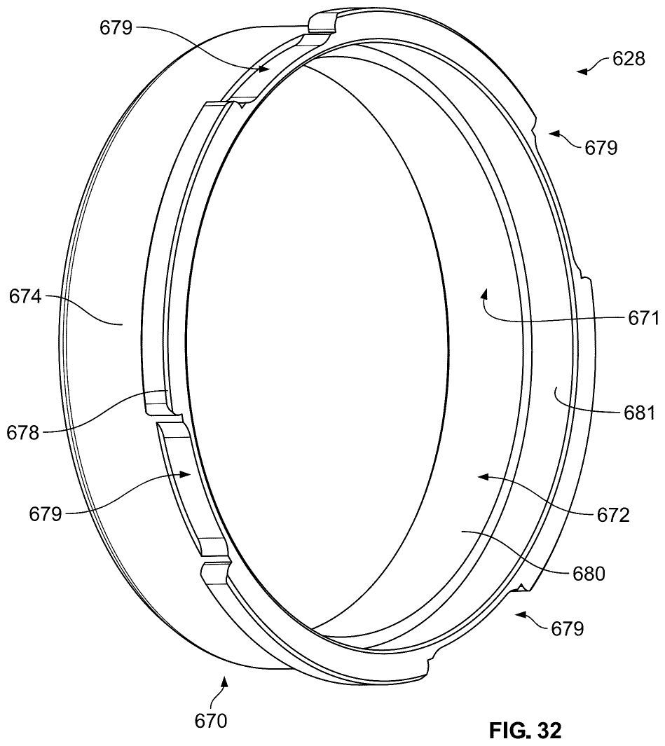

FIG. 32 is a front perspective view of an example outer sleeve 628. In some examples, the outer sleeve is similar in many aspects to the outer sleeve 128 and includes an outer surface 670, an inner surface 672, and a central opening 671.

In some examples, the outer surface 670 includes a press fit portion 674. In some examples, the outer surface 670 does not include a threaded portion. In some examples, outer surface 670 further includes an outer ring portion 678. In some examples, the outer ring portion 678 includes multiple knockouts 679. In some examples, the outer ring portion 678 has a diameter that varies in size around the circumference of the outer ring portion 678. In some examples, the diameter of the outer ring portion 678 is less than or equal to the diameter of the press fit portion 674 at the locations of the knockouts 679 and a diameter that is greater than the diameter of the press fit portion 674 at locations other than the locations of the knockouts 679.

In some examples, the outer ring portion 678 includes four knockouts 679. In some examples, the knockouts 679 are arranged circumferentially around the outer surface 670 of the outer sleeve 628. In some examples, the number and locations of knockouts 679 corresponds to the number of protrusions 686 arranged around the hub shell 614.

In some examples, the inner surface 672 of the outer sleeve 628 is similar in many aspects to the inner surface 172 of the outer sleeve 128 such that the inner surface includes a sprag contacting surface 680 and a bearing contacting surface 681. In some examples, as shown in the example of FIG. 32, the inner surface 672 of the outer sleeve 628 does not include a featured periphery 182.

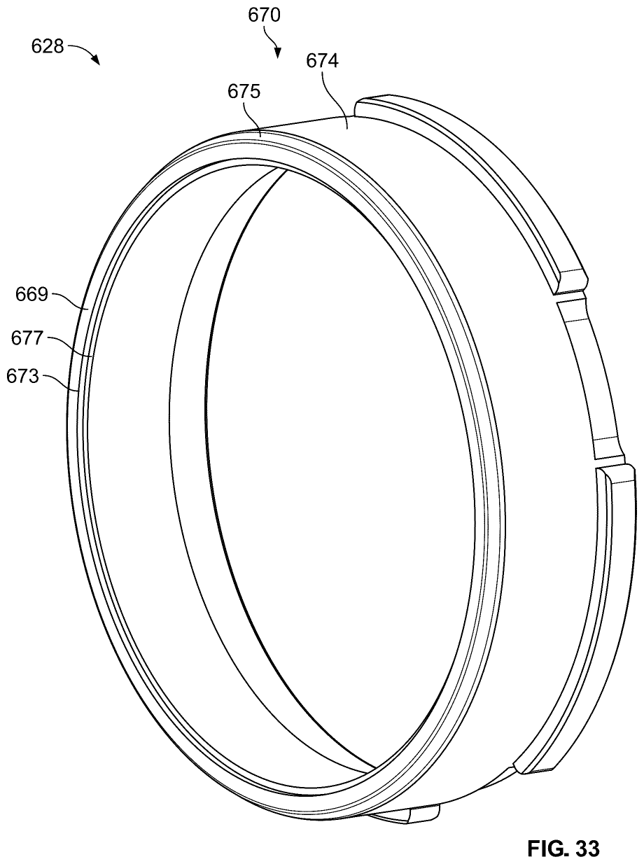

FIG. 33 is a rear perspective view of the example outer sleeve 628. In some examples, the outer surface 670 of the outer sleeve 628 further includes a tapered portion 675, a rear face 669, and a recessed rear face 677. In some examples, the tapered portion 675 extends along the outer surface 670 of the outer sleeve 628 from the press fit portion 674 to the rear face 669. In some examples, the diameter of the outer surface 670 decreases along the tapered portion 675 from the diameter of the press fit portion 674. In some examples, the rear face 669 extends between the innermost portion of the tapered portion 675 towards the central opening 671 of the outer sleeve 628, at which point the rear face 669 terminates at a shoulder 673. In some examples, the shoulder 673 separates the rear face 669 from the recessed rear face 677. In some examples, the recessed rear face 677 is substantially parallel to the rear face 669 and is offset from the rear face 669 in a direction forwards the bearing contacting surface 681 of the outer sleeve 628.

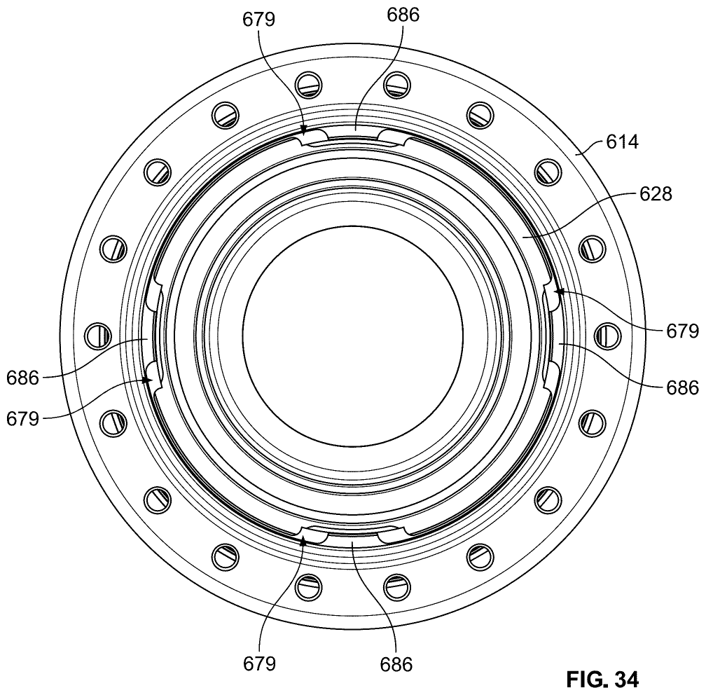

FIG. 34 is a side view of the example hub shell 614 with the outer sleeve 628 arranged therein. As shown in the example of FIG. 34, when arranged in the hub shell 614, the outer surface 670 of the outer sleeve 628 contacts the sixth diameter portion d6 of the hub shell 614 (labeled in FIG. 31). In some examples, when the outer sleeve 628 is arranged within the hub shell 614, the protrusions 686 of the hub shell 614 are arranged within the knockouts 679 on the outer sleeve 628. In some examples, the knockouts 679 are formed to be circumferentially longer than the protrusions 686. In some examples, because the knockouts 679 are circumferentially longer than the protrusions 686, in some examples, the outer sleeve 628 is able to rotate a certain distance with respect to the hub shell 614 until the edge of the protrusions 686 contact the edge of the knockout 679 on the outer sleeve 628. As such a point, the contact between the edge of the protrusions 686 contact the edge of the knockout 679 stops the rotation of the outer sleeve 628 with respect to the hub shell 614. In some examples, the edge of the protrusions 686 are formed with a curved concave shape and the edge of the knockouts are formed as a convex shape. In some examples, the concave shape of the edge of the protrusions 686 is formed complementary to the convex shape of the edge of the knockout 679.

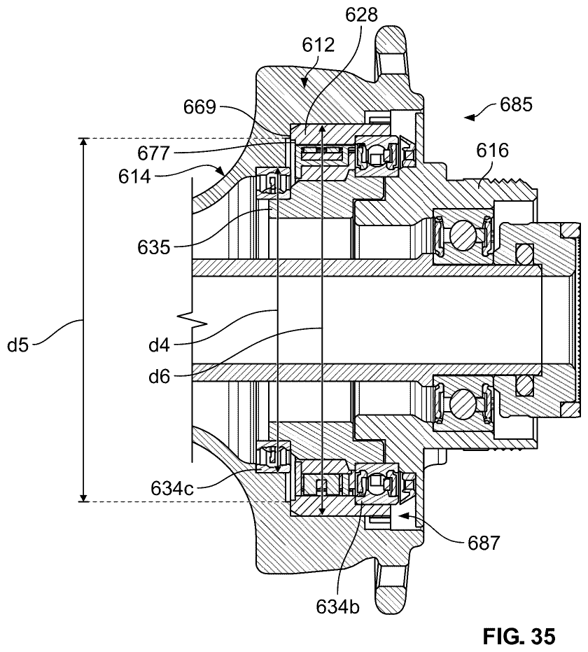

FIG. 35 is a detail view of the clutch assembly 612 of the hub 610 of FIG. 29. In some examples, the outer sleeve 628 is configured to be used with the clutch assembly 612 in a substantially similar manner to the outer sleeve 128 described with respect to the hub 110.

In some examples, the hub 110 is assembled by inserting the outer sleeve 628 into the hub shell 614. In some examples, the outer sleeve 628 is inserted into the hub shell 614 by pressing the outer sleeve 628 into the hub shell 614. In some examples, the outer sleeve 628 can be pressed into the hub shell 614 by hand or by using a tool, such as a bearing press. In some examples, the outer sleeve 628 is able to be pressed into the hub shell 614 with an interference fit between the outer sleeve 628 and the hub shell 614. In some examples, the interference fit is generated by a differential in diameters of the outer sleeve 628 and the hub shell 614 in a range between approximately 0.002″ and approximately 0.003″, such as, for example, a range between 0.002″ and 0.003″. In some examples, the interference fit is generated by a differential in diameters of the outer sleeve 628 and the hub shell 614 of approximately 0.0001″, such as, for example, 0.0001″. In some examples, the outer sleeve 628 is inserted into the internal cavity 687 of the hub shell 614 from the second end 685 such that the press fit portion 674 presses against and contacts the sixth diameter portion d6 of the hub shell 614. In some examples, the outer sleeve 628 is pressed into the hub shell 614 until the rear face 669 of the outer sleeve 628 contacts a face on the hub shell 614 that extends between the sixth diameter portion d6 and the fifth diameter portion d5 of the hub shell 614, at which point the outer sleeve 628 is prevented from being pressed into the hub shell 614 any further. In some examples, the outer sleeve 628 is rotatably arranged with respect to the hub shell 614 such that the protrusions 686 (not pictured) of the hub shell 614 are arranged within the knockouts 679 (not pictured) of the outer sleeve 628 as the outer sleeve 628 is pressed into the hub shell 614.

In some examples, after the outer sleeve 628 is pressed into the hub shell 614, the other components of the clutch assembly 612 are inserted into the internal cavity 687 of the hub shell 614.

In some examples, the outer sleeve 628 is able to be removed from the hub shell 614. In some examples, to remove the outer sleeve 628, each of the other components of the clutch assembly 612 are first removed from the hub shell 614. In some examples, bearings 634b and 634c are also removed from the hub shell 614. Thus, bearing 634c is able to be removed from the hub shell 614 prior to removing the outer sleeve 628. In some examples, after the bearing 634c is removed from the internal cavity 687 of the hub shell 614, a bearing removal tool can be used to remove the outer sleeve 628 from the hub shell 614. Specifically, a flange of the bearing removal tool can be inserted into a cavity formed by the fifth diameter portion d5 of the hub shell 614, a wall of the hub shell 614 that extends between the fifth diameter portion d5 and the fourth diameter portion d4, and the recessed rear face 677 of the outer sleeve 628. In such examples, the flange of the bearing removal tool is able to contact the recessed rear face 677 as the bearing removal tool is pulled towards the second end 685 of the hub shell 614 which causes the outer sleeve 628 to be pulled out of its press fit position within the hub shell 614 and removed from the internal cavity 687 of the hub shell 614.

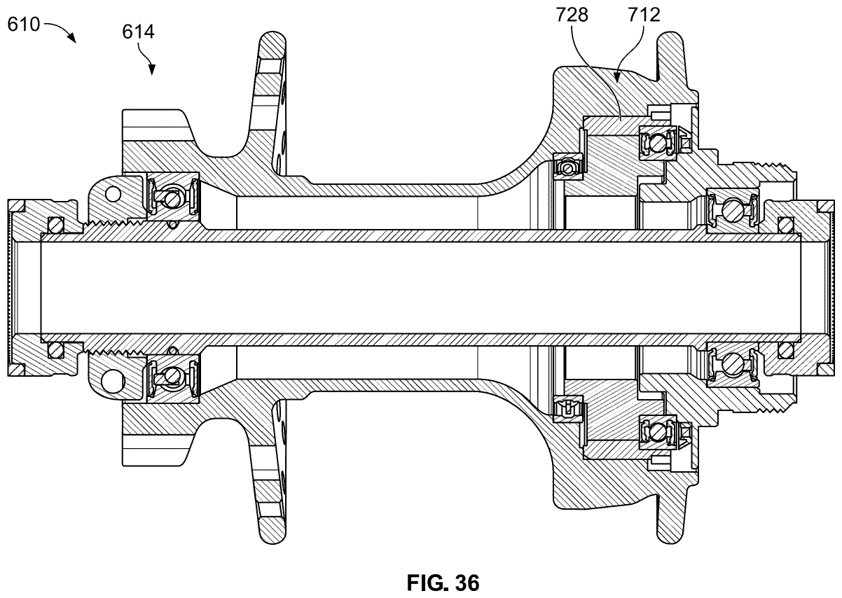

FIG. 36 is a cross sectional view of an alternative embodiment of the hub 610. In some examples, the hub 610 includes a clutch assembly 712. In some examples, like the clutch assembly 212 which is an interchangeable replacement for the clutch assembly 112 used with the hub 110, the clutch assembly 712 is an interchangeable replacement for the clutch assembly 612 used with the hub 610. In some examples, the clutch assembly 712 is similar in many aspects to the clutch assembly 212. In some examples, the clutch assembly 712 comprises an outer sleeve 728.

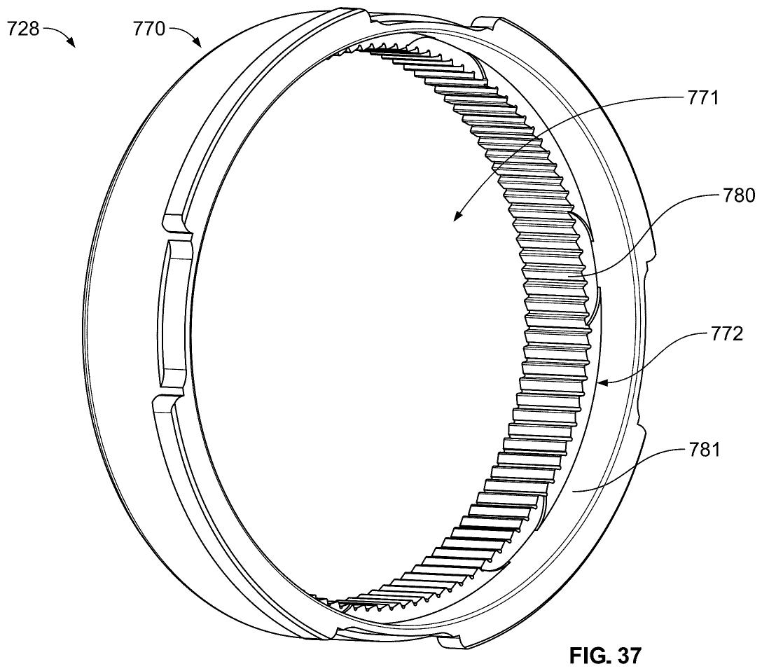

FIG. 37 is a perspective view of an example outer sleeve 728. In some examples, the outer sleeve 728 is similar in many aspects to the outer sleeve 628. For example, in some examples, the outer surface 770 of the outer sleeve 728 is similar in many aspects to the outer surface 670 of the outer sleeve 628. Similarly, in some examples, the outer sleeve 728 further includes a rear surface, recessed rear surface, and shoulder which are similar in many aspects to the rear surface 669, recessed rear face 677, and shoulder 673 of the outer sleeve 628.

In some examples, the outer sleeve 728 also includes a central opening 771 and an inner surface 772. In some examples, the inner surface of the outer sleeve includes a pawl contacting surface 780 and a bearing contacting surface 781. In some examples, the pawl contacting surface 780 is similar in many aspects to the pawl contacting surface 280 of the outer sleeve 228. In some examples, the bearing contacting surface 781 is similar in many aspects to the bearing contacting surface 681 of the outer sleeve 628. In some examples, like the outer sleeve 628, in some examples, the inner surface 772 of the outer sleeve 728 does not include a featured periphery, such as the featured periphery 282 described with respect to the outer sleeve 228.

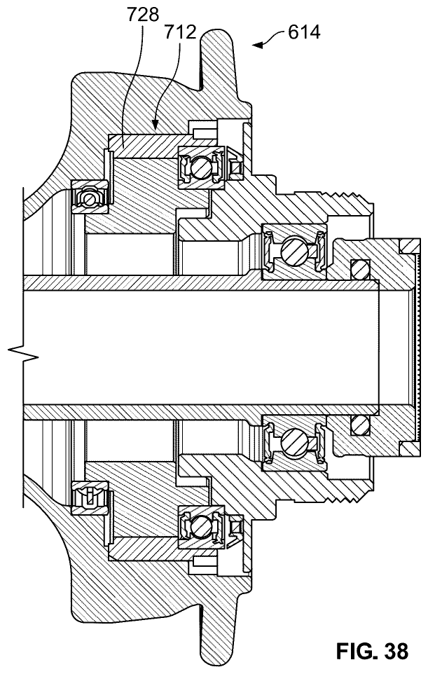

FIG. 38 is a detail view of the clutch assembly 712 of the hub 610 of FIG. 36. In some examples, the clutch assembly 712 is configured to operate similarly in many aspects to the clutch assembly 212 of the hub 110. In some examples, the outer sleeve 728 is configured to be inserted and removed similarly in many aspects to the outer sleeve 628 of the hub 610.

While the hub 610 is specifically described as capable of operating using clutch assemblies 612, 712, in some examples, the hub 610 is also configured to operate using additional clutch assemblies, such as clutch assemblies that are similar in many aspects to the clutch assembly 312. In some examples, such a clutch assembly could be configured to include an outer sleeve that is similar in many aspects to the outer sleeves 628, 728. In some examples, such an outer sleeve could be configured to include a clutch member contacting portion similar in many aspects to the clutch member contacting surface 380 of the clutch assembly 312.

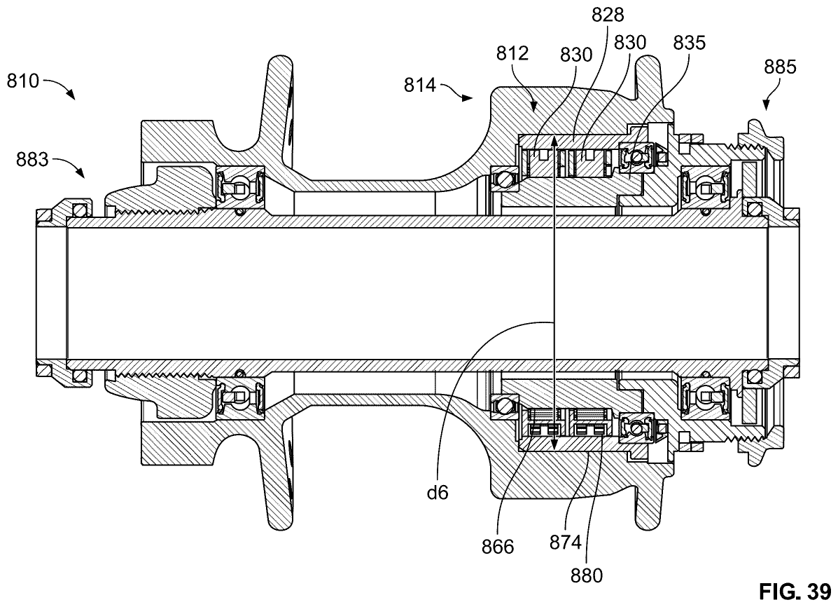

FIG. 39 is cross sectional view of another example hub 810. In some examples, the hub 810 and the components thereof are similar in many aspects to the hub 610 and the components thereof. In some examples, the hub 810 is used for certain applications such as, for example, e-bike application or professional sports, in which higher levels or torque are applied to the hub.

In some examples, the hub 810 includes a hub shell 814 and a clutch assembly 812. In some examples, the clutch assembly 812 is similar in many aspects to the clutch assembly 612 except that the clutch assembly 812 includes two sprag frame assemblies 830.

In some examples, the clutch assembly 812 includes an outer sleeve 828 and an inner sleeve 835. In some examples, the outer sleeve 828 is similar in many aspects to the outer sleeve 628, the inner sleeve is similar in many aspects to the inner sleeve 635 (which is similar in many aspects to the inner sleeve 135), and the hub shell 814 is similar in many aspects to the hub shell 614. In some examples, each of the hub shell 814, the inner sleeve 835, and outer sleeve 828 are modified to accommodate the two sprag frame assemblies included in the clutch assembly 812.

Specifically, in some examples, the hub shell 814 is modified such that the sixth diameter portion d6 is extended toward the first end 885 of the hub 810. Similarly, in some examples, the outer sleeve 828 is modified such that the press fit portion 874 and the sprag contacting surface 880 are extended. Similarly, in some embodiments, the inner sleeve 835 is modified such that the sprag contacting surface 866 is extended.

While the hub 810 is specifically described as capable of operating using clutch assembly 812, in some examples, the hub 810 is also configured to operate using additional clutch assemblies, such as clutch assemblies that are similar in many aspects to the clutch assemblies 212 or 312. In some examples, such clutch assemblies could be configured to include inner sleeves such as inner sleeves 235, 335 and outer sleeves such as outer sleeves 228, 328 that are modified in a similar manner to how the inner sleeve 835 and outer sleeve 828 are modified from inner sleeve 135 and outer sleeve 628.

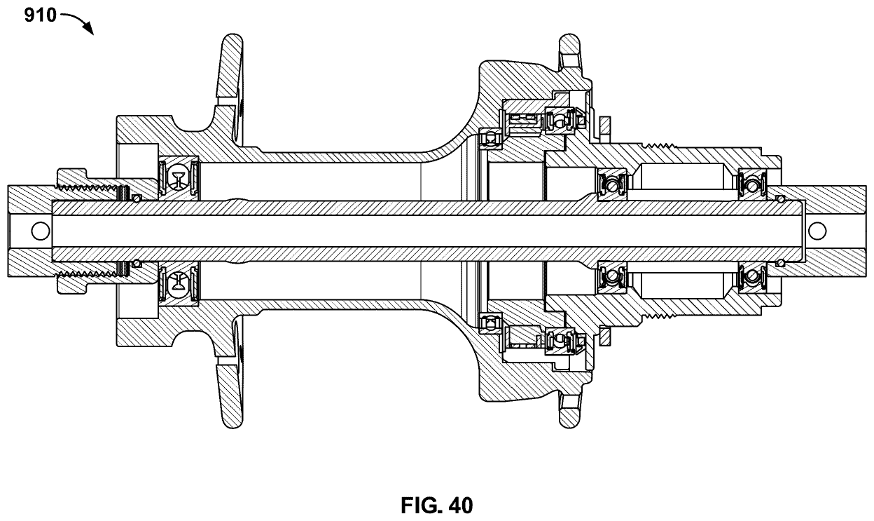

FIG. 40 is a cross sectional view of another example hub 910. In some examples, the hub 910 is similar in many aspects to the hub 610. In some examples, the hub 910 differs from the hub 610 for many similar reasons as the hub 410 differs from the hub 110. In some examples, the hub 910 includes bearings that are formed and arranged in many similar aspects to the bearings 434 shown and described with reference to the hub 410. In some examples, the hub 910 may be provided with various clutch assemblies. In some examples, such clutch assemblies are similar in many aspects to the clutch assemblies shown and described with respect to the hub 610. Furthermore, in some examples, the hub 910 may be modified in similar aspects to the hub 810.

This disclosure should be understood to include (as illustrative and not limiting) the subject matter set forth in the following numbered clauses:

Clause 1: A bicycle hub comprising:
a hub shell including an internal cavity;
an outer sleeve arranged within the internal cavity of the hub shell, the outer sleeve having a central opening; and
a driver arranged within the internal cavity of the hub shell and the central opening of the outer sleeve.

Clause 2: The bicycle hub of clause 1, wherein the outer sleeve further includes a plurality of tool engagement features arranged thereon.

Clause 3: The bicycle hub of any one of clauses 1-2, wherein the bicycle hub further comprises a plurality of sprags arranged between the outer sleeve and the driver.

Clause 4: The bicycle hub of any one of clauses 1-2, wherein the driver includes a plurality of pawls arranged thereon.

Clause 5: The bicycle hub of any one of clauses 1-2 and 4, wherein the outer sleeve further includes an inner surface with a plurality of teeth arranged thereon.

Clause 6: The bicycle hub of any one of clauses 1-3, wherein the outer sleeve further includes a smooth inner surface.

Clause 7: The bicycle hub of any one of clauses 1-6, wherein the outer sleeve further includes a press fit portion with a cylindrical surface that is press fitted into the internal cavity of the hub shell.

Clause 8: The bicycle hub of any one of clauses 1-7, wherein the driver includes a freehub and a driver component.

Clause 9: The bicycle hub of clause 8, further comprising a bearing.

Clause 10: The bicycle hub of clause 9, wherein the bearing contacts an outer surface of both the driver component and the freehub.

Clause 11: The bicycle hub of clauses 8-10, wherein the driver component is an inner sleeve with a clutch member contacting surface.

Clause 12: The bicycle hub of any one of clauses 8-11, wherein the driver component is a pawl assembly.

Clause 13: The bicycle hub of any one of clauses 8-12, wherein the freehub and the driver component are connected to each other with a male-to-female style keyed interface.

Clause 14: The bicycle hub of clause 13, wherein a male component of the male-to-female style keyed interface includes a smooth outer surface with a plurality of undulations arranged thereon, and wherein a female component of the male-to-female style keyed interface includes a smooth inner surface with a plurality of undulations arranged thereon.

Clause 15: The bicycle hub of any one of clauses 1-14, wherein the internal cavity of the hub shell includes internal threads arranged therein.

Clause 16: The bicycle hub of any one of clauses 1-15, wherein the outer sleeve includes an outer surface with a threaded portion with external threads that interface with the internal threads of the hub shell.

Clause 17: The bicycle hub of any one of clauses 1-16, wherein the internal cavity of the hub shell comprises a first diameter portion and a second diameter portion with a wall extending therebetween;
wherein the outer sleeve includes a central opening and a rear face, a portion of the rear face contacting the wall when the outer sleeve is secured within the internal cavity of the hub shell; and
wherein the bicycle hub further comprises a cavity defined by the second diameter portion and the rear face of the outer sleeve when the outer sleeve is removably secured within the internal cavity of the hub shell.

Clause 18: A bicycle hub comprising:
a hub shell including an internal cavity; and
a driver including an inner sleeve portion with a sprag contacting surface that is coaxially arranged with the internal cavity of the hub shell and a freehub portion, the sprag contacting surface including a first outer diameter and the freehub portion including a second outer diameter, the first outer diameter being larger than the second outer diameter.

Clause 19: The bicycle hub of clause 18, further comprising a plurality of sprags arranged around the sprag contacting surface.

Clause 20: The bicycle hub of any one of clauses 18-19, further comprising an outer sleeve arranged around the plurality of sprags and the sprag contacting surface.

Clause 21: The bicycle hub of any one of clauses 18-20, wherein the outer sleeve includes an outer surface, wherein the outer surface includes a threaded portion and a press fit portion, wherein the threaded portion engages with internal threads of the hub shell and the press fit portion is pressed into the hub shell.

Clause 22: A clutch assembly for a bicycle hub, the clutch assembly comprising:
a driver; and
an outer sleeve including:
   an inner surface with a clutch element contacting surface
   arranged thereon; and
   an outer surface.

Clause 23: The clutch assembly of clause 22, wherein the outer surface of

the outer sleeve further includes a threaded portion with external threads arranged thereon and a press fit portion.

Clause 24: The clutch assembly of any one of clauses 22-23, further comprising a plurality of sprags arranged between the outer sleeve and the driver.

Clause 25: The clutch assembly of any one of clauses 22-24, wherein the press fit portion is a tapered cylindrical surface.

Clause 26: The clutch assembly of any one of clauses 22-25, further comprising a second press fit portion.

Clause 27: The clutch assembly of any one of clauses 22-26, wherein the threaded portion is arranged between the press fit portion and the second press fit portion.

Clause 28: The clutch assembly of any one of clauses 22-27, further comprising a plurality of pawls arranged within the outer sleeve.

Clause 29: The clutch assembly of any one of clauses 22-28, wherein the plurality of pawls are connected to the driver.

Clause 30: The clutch assembly of any one of clauses 22-29, further comprising a plurality of clutch elements arranged between the outer sleeve and the driver.

Clause 31: A clutch assembly for a bicycle hub, the clutch assembly comprising:
an outer sleeve including a clutch element contacting surface; and
a driver component arranged within the outer sleeve, the driver component including a freehub engagement portion configured to receive a portion of a freehub therein, the freehub engagement portion having a smooth inner surface with a plurality of undulations arranged thereon.

Clause 32: A freehub for a bicycle hub, the freehub comprising:
a cog engagement portion; and
a driver component engagement portion configured to be inserted into a portion of a driver component of the bicycle hub, the driver component engagement portion including a smooth outer surface with a plurality of undulations arranged thereon.

Clause 33: The freehub of clause 32, wherein the driver component is an inner sleeve with an outer surface including a clutch member contacting surface.

Clause 34: The freehub of clause 32-33, wherein the driver component is a pawl assembly.

Clause 35: A bicycle hub system comprising:
a hub shell with an internal cavity;
a first clutch assembly comprising an outer sleeve and a driver; and
a second clutch assembly comprising an outer sleeve and a driver;
wherein the outer sleeve of the first clutch assembly is removably secured within the internal cavity of the hub shell; and
wherein upon removal of the outer sleeve of the first clutch assembly from the internal cavity of the hub shell, the outer sleeve of the second clutch assembly is removably secured within the internal cavity of the hub shell.

Clause 36: The bicycle hub system of clause 35,
wherein the first clutch assembly is one of a pawl style clutch assembly, a sprag style clutch assembly, or a clutch assembly utilizing clutch elements that include a wedge portion and an interlocking portion; and
wherein the second clutch assembly is one of a pawl style clutch assembly, a sprag style clutch assembly, or a clutch assembly utilizing clutch elements that include a wedge portion and an interlocking portion.

Clause 37: The bicycle hub system of any one of clauses 35-36, wherein the outer sleeve of the first clutch assembly and the outer sleeve of the second clutch assembly are removably secured within the internal cavity of the hub shell using screw threads.

Clause 38: The bicycle hub system of any one of clauses 35-37, wherein the outer sleeve of the first clutch assembly and the outer sleeve of the second clutch assembly each include a press-fit portion for pressing into the internal cavity of the hub shell.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A bicycle hub comprising:
a hub shell including an annular internal cavity that extends laterally from a first end of the hub shell to a second end of the hub shell, the annular internal cavity comprising a first internal diameter portion, a second internal diameter portion, a hub shell first shoulder, and a hub shell second shoulder, the first internal diameter portion having a first diameter that is less than a second diameter of the second internal diameter portion, the first internal diameter portion extending laterally away from the second end of the hub shell and terminating at the hub shell first shoulder, the second internal diameter portion extending laterally away from the second end of the hub shell and terminating at the hub shell second shoulder;
an outer sleeve arranged within the annular internal cavity of the hub shell, the outer sleeve including an outer sleeve first sidewall, an outer sleeve second sidewall, an outer surface extending between the outer sleeve first sidewall and the outer sleeve second sidewall, an inner surface extending between the outer sleeve first sidewall and the outer sleeve second sidewall, and a central opening, the outer sleeve first sidewall being arranged in an outer sleeve first sidewall reference plane, the outer sleeve first sidewall contacting the hub shell second shoulder, the outer surface of the outer sleeve contacting the second internal diameter portion of the hub shell;
a driver comprising an inner sleeve, the inner sleeve being received within the annular internal cavity of the hub shell adjacent the second end of the hub shell, the inner sleeve of the driver including a stepped outer profile, the inner sleeve of the driver including a first bearing interfacing cylindrical surface having a third diameter, a sprag interfacing cylindrical surface that is coaxially arranged with the annular internal cavity of the hub shell located adjacent the first bearing interfacing cylindrical surface and including a fourth diameter that is larger than the third diameter, a driver first shoulder arranged between the first bearing interfacing cylindrical surface and the sprag interfacing cylindrical surface, and a second bearing interfacing cylindrical surface located adjacent the sprag interfacing cylindrical surface and including a fifth diameter that is larger than the fourth diameter;
a first bearing, the first bearing comprising a width extending between a first bearing first sidewall and a first bearing second sidewall, an inner race having an inner surface, and an outer race having an outer surface, wherein:
the inner surface of the first bearing contacts the first bearing interfacing cylindrical surface of the driver;
the outer surface of the first bearing contacts the first internal diameter portion of the hub shell;
the outer race of the first bearing contacts the hub shell first shoulder;
the inner race of the first bearing contacts the driver first shoulder;
the outer surface of the first bearing has a sixth diameter that is less than a seventh diameter of the inner surface of the outer sleeve; and
the first bearing extends at least to the outer sleeve first sidewall reference plane of the outer sleeve;
a sprag frame assembly comprising a plurality of sprags located between the inner surface of the outer sleeve and the sprag interfacing cylindrical surface of the inner sleeve; and
a second bearing comprising an inner race that contacts the second bearing interfacing cylindrical surface of the driver.

2. The bicycle hub of claim 1, wherein the hub shell further includes a third internal diameter portion arranged between the first internal diameter portion and the second internal diameter portion, the third internal diameter portion extending away from the second end of the hub shell and terminating in a hub shell third shoulder.

3. The bicycle hub of claim 2, wherein the first internal diameter portion extends from the hub shell third shoulder to the hub shell first shoulder.

4. The bicycle hub of claim 2, wherein the second internal diameter portion extends from the hub shell second shoulder to the hub shell third shoulder.

5. The bicycle hub of claim 1, wherein the second internal diameter portion comprises a threaded portion and a press fit portion.

6. The bicycle hub of claim 1, wherein the first bearing second sidewall is positioned laterally between the first bearing first sidewall and the second end of the hub shell, and wherein the first bearing second sidewall is coplanar with the outer sleeve first sidewall reference plane.

7. The bicycle hub of claim 1, wherein the driver comprises a freehub.

8. The bicycle hub of claim 7, wherein the second bearing contacts the freehub and the inner sleeve of the driver.

9. The bicycle hub of claim 1, wherein the driver and the hub shell are permitted to rotate relative from each other in a first direction, and wherein the driver and the hub shell are restricted from rotating relative to each other in a second direction.

10. The bicycle hub of claim 1, wherein the sprag frame assembly comprises a spring.

11. The bicycle hub of claim 10, wherein the spring of the sprag frame assembly biases the plurality of sprags against the sprag interfacing cylindrical surface of the inner sleeve.

12. The bicycle hub of claim 11, wherein the sprag frame assembly further comprises a frame.

13. The bicycle hub of claim 12, wherein the plurality of sprags are permitted to rotate in place on the frame.

14. The bicycle hub of claim 13, wherein the sprag frame assembly is positioned laterally between the first bearing and the second bearing.

15. The bicycle hub of claim 1, wherein the inner race of the second bearing comprises a width extending between a second bearing inner race first end and a second bearing inner race second end, wherein the inner race of the second bearing contacts the second bearing interfacing cylindrical surface of the driver at the second bearing inner race first end, and wherein the inner race of the second bearing contacts the second bearing interfacing cylindrical surface of the driver at the second bearing inner race second end.

16. The bicycle hub of claim 1, wherein the driver further comprises a fifth shoulder positioned between the second bearing interfacing cylindrical surface and the sprag interfacing cylindrical surface, wherein the fifth shoulder is positioned laterally between the outer sleeve first sidewall and the outer sleeve second sidewall.

17. The bicycle hub of claim 1, wherein the driver first shoulder comprises a chamfered portion, wherein the chamfered portion of the driver first shoulder is positioned laterally between the outer sleeve first sidewall and the outer sleeve second sidewall.

18. The bicycle hub of claim 1, wherein the driver extends out from the second end of the hub shell.

19. The bicycle hub of claim 1, wherein the hub shell further comprises a fourth internal diameter portion, the fourth internal diameter portion being positioned between the second internal diameter portion and the second end of the hub shell, the fourth internal diameter portion having an eighth diameter that is greater than the second diameter of the second internal diameter portion.

20. The bicycle hub of claim 19, wherein the second bearing is arranged within the fourth internal diameter portion of the hub shell.
